(19) United States
(12) Patent Application Publication
(10) Pub. No.: US 2013/0178270 A1
(43) Pub. Date: Jul. 11, 2013

(54) Electrical Computers and Digital Processing Systems Involving Interprogram or Interprocess Communication Regarding Risk in Amusement Devices and Games

(71) Applicants: Phillip Flaherty, Las Vegas, NV (US); Andrew Garrood, Las Vegas, NV (US)

(72) Inventors: Phillip Flaherty, Las Vegas, NV (US); Andrew Garrood, Las Vegas, NV (US)

(73) Assignee: CFPH, LLC, New York, NY (US)

(21) Appl. No.: 13/591,615

(22) Filed: Aug. 22, 2012

Related U.S. Application Data
(60) Provisional application No. 61/526,050, filed on Aug. 22, 2011.

(51) Int. Cl. A63F 13/00

(52) U.S. Cl. CPC A63F 13/00
USPC 463/16

(57) ABSTRACT

Various methods and apparatus related to gaming are described. Some embodiments relate to managing risk. Risk may be managed across different jurisdictions and among a plurality of wagering venues. Other embodiments are described.

This application claims priority to U.S. provisional application 61/526,050, filed Aug. 22, 2011 which is hereby incorporated herein by reference.

### FIELD

Some embodiments relate to gaming.

### BACKGROUND

Casinos may offer one or more wagers to one or more players. Some games may be played by a single player and some games may be played by multiple players.

### BRIEF DESCRIPTION OF THE FIGURES

FIG. 1 shows a block diagram of components for a hand-reading system, according to some embodiments;

FIG. 2 shows an apparatus for playing a game, according to some embodiments;

FIG. 3 shows an example method according to some embodiments; and

Some embodiments may include various events or propositions that may be wagered upon, such as outcomes of an election, winnings of an award, and so on. Some embodiments may include wagers on an outcome of a season of a game, a season of a television show (e.g., Survivor), and so on. Some embodiments may include wagers on other casino games (e.g., craps, blackjack, slots, poker). Such bets may include bets on individual games, bets on other people, bets on statistics of the games, bets on tournaments of such games, and so on. It should be recognized that the examples of various wager types and odds types are given as non-limiting examples only and that various embodiments may include any desired wager types and/or odds types.

### Example Embodiments

Some gambling systems enable users to bet on the outcome of a game, e.g., which team will win, and/or by how much. Gaming operators try to determine accurate probabilities for each game outcome (e.g., win, loss, and point spread) so that they can offer competitive odds to potential bettors who may bet on each outcome. The probabilities (and/or odds) are typically determined prior to the start of the game and/or start of wagering on the game based on information existing prior to the game, such as historical data related to each team, player, and coaching staff, ratings and opinions of professionals such as sportswriters and other coaches, and other public and proprietary information related to the game. For instance, some gaming operators use complicated proprietary computer algorithms to determine odds based on pre-existing statistical information and other information. The odds may change during a betting period as bettors wager on one side or another of an outcome (e.g., if many people wager that team A will win and few people wager that team B will win, the odds may become less favorable for a wager that team A will win), as events occur (e.g., a player is injured, and so on), and so on.

Some gaming operators allow users to bet on performance parameters within a game, such as whether a particular player will strike out in a particular at-bat in a baseball game, how many punches will land in a round of boxing, how far a golf ball will fly in a round of golf, what cards will be dealt in a flop of a poker game, and so on. The betting market is typically opened manually and/or in automatically in response to a reading of a data stream or determination that the event is upcoming prior to the in-game event.

Odds for such wagers maybe determined in any manner, such as manually or automatically based on historical records regarding similar events, player statistics, weather information, and so on. In some situations, even if another gaming operator offered a similar bet, the quick timing of such a bet may prevent gaming operators and bettors from comparing the different odds offered. In these circumstances, the gaming operator may attempt to offer odds without the benefit of a competitive betting market based entirely on the operator's best assessment of the probabilities of the various outcomes.

In effect, odds are a gaming operator's “price” to bettors for wagering on a specific outcome (wherein higher odds translate to a lower price for the bettor). When there are a plurality of gaming operators offering odds on a particular outcome to a plurality of bettors, the gaming operators may compete with one another to offer a competitive price that will attract bettors who seek the highest payout for their betting dollar. Thus, gaming operators may determine odds based in part on the odds offered by competing gaming operators. Betting behavior can also affect odds. For instance, a high demand for bets that the Chicago Cubs will win their next game against the Phillies may drive up the effective price for that bet. Accordingly, as in other competitive marketplaces, odds determinations often reflect a “market price” for each game outcome, as gaming operators adjust their odds based on the market. The effective market price can change over time as the betting market changes and new relevant information is disclosed, such as an injury of a key Cubs pitcher a day before the game. Notably, amounts wagered by losers on one side of the bet can be used to fund the payout to winners on the other side of the bet. Thus, in large betting markets where there are many bettors on each side of a bet, gaming operators may adjust their odds in an effort to balance the potential payouts on either side of the bet.

According to various embodiments of the present invention, a system may enable users to bet on in-game events, such as whether a particular baseball player strikes out in a particular at-bat, and/or more traditional game outcomes, such as which team will win and/or by how much. The system may automatically receive general game information (e.g., team names, player rosters, start time, etc.) from a data feed or other source. From the same data source (or another source), the system may also automatically receive a stream of real-time game information, such as elapsed time, batting line-up, runs scored, errors on a play, pitch information (strike, ball, foul), etc.

Odds for each event, such as a strike-out or a game winner, may be calculated based on an odds database and algorithm stored on the system, manually, and/or in any manner. The algorithm may use information from the real sport (such as a player's batting average), and may be updated based on in-game events. (E.g., if Barry Bonds strikes out four times with the same pitcher, his odds of getting a hit off that pitcher may decrease).

In some embodiments, when a specific gambling event is completed (e.g., as soon as/after Barry Bonds finishes his at-bat by striking out or hitting a home run, after a game is completed), the system settles the bets placed on that betting event. At the same time (or another time), the system may open the betting for another event (e.g., the next at-bat). In one embodiment, a human operator clears the bets after each event. For example, the human gaming agent may select “strike out” immediately after Barry Bonds strikes out. This operation may cause the system to immediately settle all the bets on the present Barry Bonds at-bat and also open bets for the next betting event (e.g., the outcome of the next batter's at-bat). In other embodiments, the system may use automated information (e.g., a data feed) to determine event outcomes (like a strike-out) in real time. In some embodiments, human gaming agents may assist with error correction to ensure that the system identifies correct outcomes and resolves all bets properly.

Users may place bets and otherwise interact with the system and other users via an interface such as a gaming table or mobile touch-screen gaming device, which may be configured to display a live TV feed of an event such as a baseball game with an optional touch-sensitive betting interface overlay. In one embodiment, when Barry Bonds steps up to the plate, a user may touch the image of Barry Bonds (or other image or icon) to trigger the betting interface overlay that enables the user to select and place a specific bet concerning Barry's at-bat. To bet that Barry will get a single, the user may touch an image of first base (or provide another appropriate input). In some embodiments, before, at the beginning and/or during a game or sports season players may wager on one or more games or other events.

Various embodiments of the system may enable gambling on many different types of outcomes within a single game or other event, such as whether a particular runner steals a particular base, the number of runs scored in an inning, whether a pitcher throws a ball or strike on a given pitch, etc. and/or related to a whole game or set of games (e.g., who will win a tournament, who will win a game). The system may open and close each betting event based on the start and finish time of that particular event. The system can also be applied to a variety of sports as well as other events, such as elections (e.g., whether Barack Obama will win New Hampshire in the upcoming 2008 presidential election). It should be appreciated that various embodiments of the invention may manage many different betting markets at simultaneous or overlapping times. Each betting market may be opened, closed, and resolved based on the terms of that specific betting market, independently of other betting markets.

It should be recognized that various embodiments may include any type of wager, such as, for example, in-game wagers on sports or other events, wagers on outcomes of games or other events, and so on. It should be recognized that various embodiments may include any systems and/or methods for determining initial and/or future odds for any wager, such as, for example, an exchanged based system, a wager line set by a sports book algorithm and/or employee, and so on. It should be recognized that various embodiments may include any system and/or method for placing and/or managing wagers, such as, for example, a centralized computer system, a distributed computer system, one or more servers, one or more client computers, an in person system., a ticket system, a mobile system, and so on. Some examples of wager types, systems and methods for determining odds, and systems and methods for placing and managing wagers are described in U.S. patent application Ser. No. 12/258,297 to Storm and entitled Wager Market Creation and Management, which is hereby incorporated herein by reference.

In some embodiments, when a gaming operator (e.g., an operator of one or more sports books) accepts a wager from a user, the gaming operator may take on some risk. For example, the gaming operator may take on the risk that the player that makes the wager may win the wager and as a result the gaming operator may be required to pay the player some amount of money. For each wager accepted by the gaming operator, some amount of risk related to an outcome of an event wagered upon may be taken on by the gaming operator.

In some embodiments, a gaming operator may desire to control an amount of risk. For example, in some embodiments, a gaming operator may take a percentage of each wager, each win, and or otherwise make money related to players wagering that is in addition to and/or an alternative to money made through lost wagers. Accordingly, such gaming operators may desire to minimize risk wager related risk because they are able to earn money without such risk. In some embodiments, gaming operators may desire some risk, and/or to maximize risk, and/or any other operation related to risk that may fit in with a business model. For example, in some embodiments, a gaming operator may make money through wager losses and therefore may desire to enter into wagers that the gaming operator believes will be losing wagers for the player based on information known by the gaming operator. Such a gaming operator may take on risk that those wagers are won by the players. It should be appreciated that a gaming operator may have various desires regarding risk that may differ from wager to wager and time to time.

In some embodiments, a gaming operator may operate in multiple jurisdictions and/or at multiple locations. For example, one gaming operator may operator sports books at a plurality of locations. One gaming operator may take the risk for wagers made at a plurality of locations (e.g., a plurality of casinos, a plurality of sports books, etc.). Such locations may include locations that are in a single city or jurisdiction and/or may span multiple jurisdictions. For example, a sports book in Las Vegas, Macau, London, and New Jersey may all be operated by a single gaming operator so that risk associated with each of these locations may be taken by the gaming operator. Such a gaming operator may include a actual single entity and/or multiple entities that may act as a single entity through some corporate structure and/or business alliance.

In some embodiments, some locations and/or jurisdictions may have different rules and/or regulations. For example, a rule may prevent some wagers from being offered, an order to place a wager from being received and/or transmitted in certain ways (e.g., at all, out of the jurisdiction, etc.), trading in wagers, and so on.

Some embodiments may include transmitting indications of wagers and/or risk from one or more gaming locations and/or gaming operators to one or more other locations, gaming operators, computing devices and so on. For example, some (e.g., each) of the locations may transmit an indication of risk and/or wagers to a centralized location (e.g., a risk manager). Such a risk manager may receive such indication and perform one or more desired actions related to such indications.

In some embodiments, some locations may consolidate location level risk and transmit such information to a risk manager. In some embodiments, some locations may transmit individual wager risks for consolidation by the risk manager. It should be recognized that any manner of communication regarding risk and/or wagers may be used in various embodiments whether consolidated, offset, individual, and/or otherwise.

Some embodiments may include consolidating risk amount the plurality of locations. For example, a plurality of wagers that an event will occur may each be associated with the same risk that the event occurs and the gaming operator must pay some money. Accordingly, such risk may be summed together into an aggregate risk that the event occurs. Accordingly, a determination of a perceived risk that an event occurs to the gaming operator may be made. Such a determination may identify an amount of money that may be owed, a weighed indicator that may be based on such amount of money, and/or any other desired indication.

In some embodiments, one risk and/or wager may offset other risk and/or another wager. For example, in some embodiments, a wager that an event will occur may have risk associated therewith that the event will occur (e.g., say 10 dollars of risk). Another wager that the event will not occur may have risk associated therewith that the event will not occur (e.g., say 5 dollars of risk). If the event is a binary event, then the risks may offset one another (e.g., say to leave 5 dollars of risk that the event will occur).

Some embodiments may include wagers that are not binary and/or not exactly the same but nonetheless offsetting in some manner. For example, in some embodiments, an event may have three or more possible outcomes (e.g., win, lose, tie; horse 1, horse 2, horse 3; etc.). In such embodiments, a wager on one outcome may not completely offset risk on a wager on another outcome. Nonetheless, at least part of such risk may be offset (e.g., half, an amount based on the chances of each outcome occurring, etc.). In some embodiments, a in game wager may in part offset risk for a pre game wager (e.g., a wager that some great event like a 100 yard run occurs in a football game by team A may in part offset risk associated with a wager that team A will lose). An amount of such offset may be based on a chance of both the in game and pre game event occurring at the same time (e.g., it is unlikely that a team will make a 100 yard run and lose a same game so such bets may offset one another a greater amount than a bet on a 50 yard run because it may be more likely that both a 50 yard run and a loss may occur). In some embodiments, a money line wager may offset a point spread wager even though they may not be a same wager. For example, a wager that the bears will win by one point may offset a wager that the bears will lose in part. An amount of such offset may be based on how likely a gaming operator may be required to payout for both wagers.

Although some embodiments have been described in terms of risk being the same as a monetary amount that may be owed, it should be recognized that other embodiment may include any indictor of risk, such as an indicator that may be based on or not based on an amount of money that may be owed. For example, in some embodiments, an algorithm may convert an amount that may be owed into some indictor of risk based on one or more input values.

For example, in some embodiments, historic information about events, and/or users may be used to weigh one or more wagers to determine risk based on those one or more wagers. In some embodiments, a determination may be made based on a player's historical wagers that the player is likely (e.g. more likely than an average player, more likely than not, etc.) to make a correct wager. In response to such a determination, risk associated with wagers made by that player may be increased. Such increase in risk may be applied to all wagers on the same side as that player. Conversely, risk associated with wagers on the other side may be decreased and/or a player that is determined to likely wager incorrectly may be used to adjust wager risk. It should be recognized that any number of players may be tracked to determine wager performance and that any level of performance may have any desired impact on risk ion the players wagers and/or other wagers. For example, in some embodiments, an algorithm may take into account a plurality of players that each have different historical success levels for wagers in different situations and may apply a weight to each one to determine a risk for a wagers on an event on which each of them wagered one or more same or different outcomes (e.g. if all successful wagers wagered on one side the risk may be increased for that side, some may be on both sides and a weighing of their successes may determine how a risk is affected, etc.).

Some embodiments may include tracking people's wagers to determine expected wager outcomes so that risk may be adjusted accordingly. In some embodiments, such tracked wager outcomes may be stored and offered for sale to other gaming operators for similar or different use. For example, a single player's wager history may be sold, a group of wager histories with a particular characteristic may be sold, a gaming operator may buy a feed of wagers for a particular player and/or a player with a characteristic (e.g., a successful wager history).

As another example, one or more events, knowledge, guesses, predictions and so on may be used to determine how to weigh one or more wagers. For example, a gaming operator may have inside knowledge that some event is unlikely to occur so may wagers based on that event accordingly.

It should be recognized that any manner of combining and/or offsetting risk to generate an aggregated risk value for an outcome of one or more events occurring may be used. Some embodiments may determine for each event an amount of risk that remains on one or more sides of an event (e.g., consolidated and offset risk may identify that 5 dollars of risk remains on the bears winning an upcoming game).

In response to determining that some amount of risk at a consolidated level remains no-offset, an attempt may be made to offset the remaining risk. Various methods of offsetting the remaining risk may be used.

For example, in some embodiments, odds may be adjusted for offsetting wagers to encourage players to accept the offsetting wagers. Such odds may be adjusted at one or more of the locations of the gaming operator. For example, a risk manager may transmit an indication of desired odds for each such offsetting wager. The locations may then adjust wager offers for such offsetting wagers to encourage players to make such wagers to offset the total risk for such an event happening.

As another example, in some embodiments, a risk manager and/or agent thereof may attempt to sell a wager on a wager exchange and/or enter into an offsetting wager on a wager exchange. For example, a risk manager may submit a bid to enter into an offsetting wager on a wager exchange. Such an offsetting wager as discussed above may be a wager that offsets all or a portion of the risk. Some embodiments may include entering into an offsetting wager at another gaming operator.

One example risk and/or odds management system is described in U.S. patent application Ser. No. 12/687,980 to Amaitis and entitled ELECTRICAL COMPUTERS AND DIGITAL PROCESSING SYSTEMS INVOLVING INTERPROGRAM OR INTERPROCESS COMMUNICATION REGARDING AMUSEMENT DEVICES AND GAMES, which is hereby incorporated herein by reference. One example of an exchange-like system for wagers is described in U.S. Pat. No. 7,233,922 to Asher and entitled System and method for wagering-based transferable financial instruments, which is hereby incorporated herein by reference.

It should be recognized that any action and/or offsetting attempts may be performed by any entity at any level in any manner. For example, in some embodiments, a local facility may attempt to offset risk, prior to and/or in response to consolidated risk being determined. Offset at such facilities and/or by a risk manager may be used as input to a risk model to determine a new level of risk which may then be used to determine odds and/or desired further offsetting.

Some embodiments may include determining liquidity for one or more potential offsetting wagers. For example, a determination may be made that an offsetting wager to the bears winning a game may be very liquid (e.g., readily obtainable through a wagering exchange). In some embodiments, a level of liquidity may be used to determine odds for a wager offered on such an event. For example, if an offsetting wager is very readily available, a wager may be offered at better odds for a player than if the offsetting wager is illiquid. In some embodiments, the liquidity of the offsetting wager compared to the liquidity of the wager may be used to determine odds.

In some embodiments, based on rules of a jurisdiction, an indication of risk at a location may be published and received by a risk manager. Such an indication of risk may not be an order to enter into an offsetting wager. In some embodiments, order to enter into an offsetting wager may be sent to a risk manager from a location. In some embodiments, separate risk pools may be maintained per location and/or wager type. In some embodiments, a risk manager may operate as an agent to maintain such risk pools at desired levels.

In some embodiments, timing related to seeking and/or entering into offsetting wagers or otherwise offsetting risk may vary based on one or more characteristic of an event. For example, in some embodiments, if an offsetting wager market is and/or is expected to be liquid, then a risk manager may determine that the offsetting may be delayed until near to an event occurrence. In contrast, in some embodiments, if an offsetting wager market is and/or is expected to be illiquid, then a risk manager may determine that the offsetting should occur sooner (e.g., as soon as possible). In some embodiments, if a larger number of wagers related to an event are expected in the future (e.g., say for a super bowl game later in the year and a wager that comes in very early), then a risk manager may delay attempts to offset the risk until closer to the event occurrence. In contrast, if few wagers related to an event are expected in the future, then a risk manager may attempt to offset risk sooner.

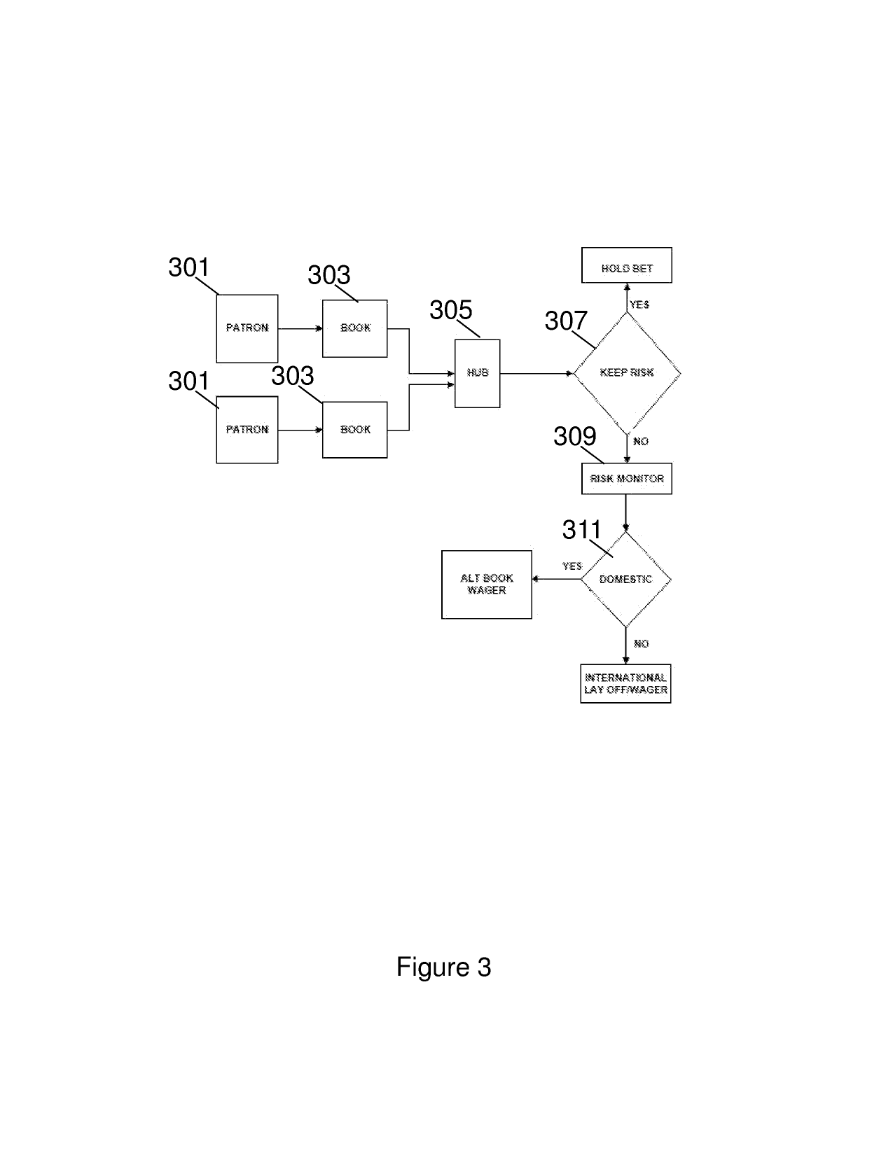

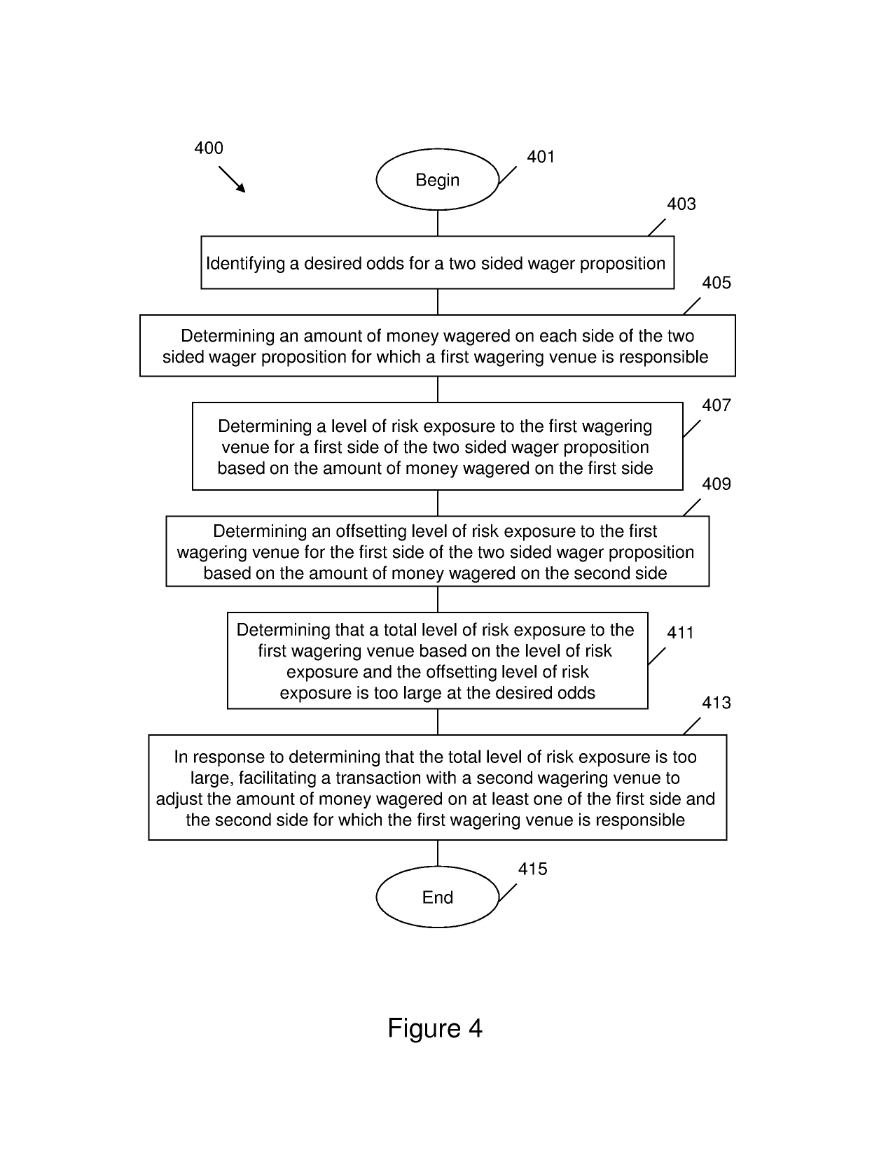

Some embodiments may include a risk management element such as a server, a computing device, a person, and/or any other entity. Such an element may be a module of a gaming system. FIG. 3 illustrates an example of a risk management module and/or method that may be used in some embodiments. Patrons 301 associated with one or more gaming locations (e.g., operations that may be in different jurisdictions and/or different locations) may place one or more wagers (e.g., wagers in any desired game such as a sports book game and/or a casino game). In some embodiments, although the users may place the bets at different locations and/or through different devices 303, the gaming provider may have a single risk pool 305 associated with the bets combined. For example, a single gaming operator may take wagers from a plurality of locations and/or jurisdictions so that operator may assume the risk of such wagers. In other embodiments, different gaming locations may separately assume elements of risk separately rather than a single gaming operator assuming the risk from activities in different locations or through different accounts.

In some embodiments, a determination of whether to maintain the risk for one or more wagers may be made as indicated at 307. Such a determination may be made based on a risk tolerance of the gaming operator. For example, a gaming operator may desire to take no more than X dollars in risk for a particular event occurring (e.g., that a team will win in a sports game, that a player will win in a casino game, that an outcome will occur in a game, etc.). If a new wager does not exceed such a threshold then a determination may be made to keep the risk. If a new wager does exceed such a threshold then a determination may be made that the risk should not be kept. In some embodiments, wagers on different things may at least in part be treated as a same risk (e.g., a wager that a player will win a game may be treated as similar to a wager that the same player may get a royal flush in the game, a wager that a team will win may be treated as a same risk that a team will win a first half of a game, etc.).

In some embodiments, a risk monitor element 309 may attempt to offload some amount of risk that an event occurs based on a determination that a gaming operator has taken on more than a threshold amount of risk. The illustrated example shows a decision 311 being made based on whether each part of the risk is domestic or international and making potentially different attempts to offload the risk based on such a determination. In some embodiments, it should be recognized that various jurisdictions at any level of granularity may have different regulations regarding offloading of risk and so different determinations regarding how such risk offloading should be made may be made based on any level of granularity of jurisdictions (e.g., state by state). For example, in some embodiments, an order to enter into a wager may be sent for one jurisdiction, a indication of a wager may be sent from another jurisdiction, and a indication of risk at a location may be sent form a third location. It should be recognized that based on different regulations different actions may be taken and/or information transmitted regarding wagers and/or risk. Although FIG. 3 illustrates domestic and foreign, it should be recognized that any number and/or arrangement of jurisdictions may be used (e.g., each state, each country, each set of countries with a same rule, etc.).

In some embodiments, one or more wagers for an over-risked event may be attempted to be offloaded and/or offset through one or more risk offloading and/or offsetting systems. For example, if a wager for the over-risked event is made in a jurisdiction in which wager exchanges are legal, the wager may be sold and/or a counter wager may be entered into through such a wager exchange. In some embodiments, if such a wager is made in a jurisdiction in which such offloading is not legal, a counter wager may be entered into in another jurisdiction (e.g., a gaming operator may place a wager at another gaming operator that the event will not happen (e.g., if the wager is a wager that the event will happen). It should be recognized that any business rules and/or jurisdictional rules may be followed regarding offloading of risk.

FIG. 4 illustrates an example method 400 that may be performed in some embodiments to adjust a responsibility for a wager by a sports book and/or gaming operator. Such a method may be performed by a central system, by a sports book, and/or by any desired element. Such an adjustment of responsibilities may be used to keep risk at a desired level, for example, so that a sports book may offer competitive odds based on a consensus odds for a wager without risking a giant loss of money. Responsibility for one side of a wager may be traded for money, responsibility for another side of a wager, and so on. Responsibility for a wager may be traded form one wagering venue to another and/or from/to any desired sour or destination. Method 400 may begin at block 401.

Responsibility for a side of a wager may include the right to take legal ownership of money or other valuables based on a loss of the side of the wager. Responsibility for a side of a wager may include the obligation to make a payment based on a win of the side of the wager.

As indicated at block 403, some embodiments may include identifying a desired odds for a two sided wager proposition. A two sided wager proposition may include an outcome of a competition, such as who will win a game of baseball, an in game wager, and so on. Some embodiments may include a wager with any number of sides. Identifying the desired odds may include selecting the odds, receiving an indication of the odds, determining the odds, and so on. A two sided wager proposition may include a fixed odds wager (i.e. a wager that is not a pari-mutuel wager), such as a wager on a sporting event that includes spread, an odds, and so on.

As indicated at block 405, some embodiments, may include determining an amount of money wagered on each side of the two sided wager proposition for which a first wagering venue is responsible. Such determination may include receiving information from one or more wagering interfaces, from one or more wagering venues, and so on. Such a determination may include summing together an amount of money that a wagering venue may be responsible for if a respective outcome of the wager occurs. Such a determination may include summing together an amount of money that a wagering venue may take ownership of if a respective outcome of the wager occurs.

As indicated at block 407, some embodiments may include determining a level of risk exposure to the first wagering venue for a first side of the two sided wager proposition based on the amount of money wagered on the first side. Such a level of risk exposure may take any form. In one example, such a level of risk exposure may include an amount of money that the wagering venue may be obligated to pay out. In some embodiments such a determination may include no additional action than the actions of block 405. Some embodiments may include reading from a database after performing block 405. Some embodiments may include performing one or more calculations on the results of block 405. Some embodiments may include determining a first amount of money that the first wagering venue may be responsible for paying out if the first side of the wager wins based on the amount of money wagered on the first side.

As indicated at block 409, some embodiments may include determining an offsetting level of risk exposure to the first wagering venue for the first side of the two sided wager proposition based on the amount of money wagered on the second side. Such a level of risk exposure may take any form. In one example, such a level of risk exposure may include an amount of money that the wagering venue may be take ownership of. In some embodiments such a determination may include no additional action that the actions of block 405. Some embodiments may include reading from a database after performing block 405. Some embodiments may include performing one or more calculations on the results of block 405. Some embodiments may include determining a second amount of money that the first wagering venue may take ownership of if the second side of the wager wins based on the amount of money wagered on the first side.

As indicated at block 411, some embodiments may include determining that a total level of risk exposure to the first wagering venue based on the level of risk exposure and the offsetting level of risk exposure is too large at the desired odds. Determining the total level of risk exposure may include performing one or more mathematical calculations on the level of risk exposure and the offsetting level of risk exposure. In some embodiments such a calculation may include subtracting the offsetting risk exposure from the risk exposure. In some embodiments determining that the level is too large at the desired odds may include determining that the level is above a certain threshold. In some embodiments, the threshold may be based on expected future wagers at the desired odds (e.g., a calculation may be made that based on prior wagers and an amount of time before wagers are no longer accepted, that there is a expectation that future wagers will result in a high level of risk exposure to one side or the other of the wager). In some embodiments, the threshold may be based on other wagers placed at the wagering venue. In some embodiments, for example, if a wagering venue has a total risk above 1 million dollars on a certain side of a wager (currently and/or expected based on prior wagers), the wagering venue may determine that continuing to offer the side of the wager at the odds may result in too much risk for the wagering venue. It should be recognized that any method of determining that a level of risk is too large at a given odds for a wager may be used in various embodiments. Some embodiments may include determining a total amount of money that the first wagering venue risks based on the first amount of money and the second amount of money. Some embodiments may include determining that the total amount of money is too large at the desired odds. The odds may not be relevant in some embodiments. For example, a determination may be made that one side of a event or proposition occurring is associated with a high level of risk (e.g., including a variety of wagers at a variety of odds summed together and offset by offsetting risk wagers with one or more different and/or similar odds).

As indicated at block 413, some embodiments may include facilitating a transaction with a second wagering venue to adjust the amount of money wagered on at least one of the first side and the second side for which the first wagering venue is responsible. In some embodiments, such facilitating may take place in response to determining that the total level of risk exposure is too large. In some embodiments, such facilitating may include trading responsibility for one or more wagers on an exchange. Such responsibility may be traded with one or more other wagering venues and/or any other desired entity. For example, in some embodiments, a buy or sell order for responsibility on a side of a wager may be submitted to an exchange. The exchange may match buyers and sellers and perform any functions to bring about an exchange of responsibility. Such a transaction may allow the wagering venue to readjust its risk level so that it may offer the wager at the desired odds.

In some embodiments, such facilitating may include placing at least one of an order to buy responsibility for wagers on the second side on a wager exchange and an order to sell responsibility for wagers on the first side on the wager exchange. It should be recognized that any method of performing such trading on with any system or method for exchanging may be used. In some embodiments, blocks of wagers may be traded. In some embodiments individual wagers may be traded. In some embodiments portions of wagers may be traded. In some embodiments, auctions for wagers may be held. In some embodiments bids and offers and hits and takes similar to a stock exchange may be used. In some embodiments, dark pools trading systems may be used. In some embodiments, time in force, execute or cancel, stop loss, and or any other desired orders may be used.

In some embodiments, a first wagering venue may pay another wagering venue or be paid by another wagering venue to take responsibility for a wager. The amount paid may be determined through a bidding process, through a reverse auction, through an exchange based system, and so on. In some embodiments, if a first wagering venue offers makes such an offer through an exchange, a portion of the offer may be filled by one or more second wagering venues. For example each of ten second wagering venues may agree to take responsibility for respective ten percent of the wager. In some embodiments, if an exchange determines that multiple wagering venues are interested in an offer regarding a change of responsibility for a wager, the exchange may use a first in first out method of determining matching desires, a pro rata method of filling matching desires, and so on. A matching engine may be used by an exchange to determine that desires match for an exchange.

Some embodiments may include offering the wager at the desired odds. For example a wagering venue that performs the method 400 may then offer the wager after reaching a level of acceptable risk at the odds.

In some embodiments, an action may be taken by a third wagering venue instead of and/or together with an action by the wagering venue. For example, a gaming operator may operate the gaming venue and the third gaming venue (e.g., may own them both, may have some contractual agreement so that they are affiliate in some way, etc.). In some examples, the wagering venue and the third wagering venue may be in different jurisdiction hat may have different rules regarding the laying off of wagers. For example, a wagering exchange or venue to venue transaction may not be allowed in the wagering venue's jurisdiction, but may be allowed in the third wagering venue's jurisdiction.

A third wagering venue may entire into an offsetting transaction in response to the wagering venue having too high of a level of risk (i.e., one venue may act based on another one or more venues' risks). This offsetting transaction may be considered to hedge the risk for the wagering venue even though the third wagering venue is the one that actually enters into the offsetting transaction with the second wagering venue. This offloading at a different jurisdiction may allow a gaming operator to take advantage of the differing legal requirements to maximize the ability to hedge against risk while operating a diverse set of wagering venues. It should be recognized that any number of wagering venues may operate together to offset each other's combined risk in any manner.

In some embodiments, a central authority may control information and/or offloading transactions for a plurality of wagering venues. Those venues may be in divergent locations and jurisdiction. A central authority may determine how the sum of risk in the variety of wagering venues offset one another and what a total risk for all of the wavering venues may be. That sum of risks across the various venues may be used as the relevant risk rather than the risk of a single venue when evaluating offsetting or hedging transactions. That central authority may control offsetting transactions to offset the total risk as desired.

For example, a central authority may determine that a sum of risk across a variety of wagering venues exceeds a threshold. That central authority may determine that a wagering venue in a particular jurisdiction is best able to enter into an offsetting transaction (e.g., it is legal to do so in that location, there is a second wagering venue that is willing to enter into such a transaction, in that jurisdiction, there is an offsetting transaction available through a wagering exchange accessible in that jurisdiction, and so on). The central authority may transmit an order to enter into that transaction to that chosen wagering venue which may then carry out the order in response to receiving the order.

Determining summed risk may include receiving risk data from a variety of wagering venues. Such risk data may include publically reported risk data, risk data identifying private information, risk data for individual wagers, sums of risk, and so on. Such data may be published on a website, sent over the internet, emailed, mailed, telephoned by person, and so on. Such transmission of and/or receipt of risk data may occur through a methodology allowed by the various jurisdictions. For example, one jurisdiction may require public disclosure of wagers and so a central authority may receive risk information via a public disclosure, while another jurisdiction requires only private transmission of risk data and the central authority may receive that information via a private transmission.

An order to take an action may include a direct request to the second wagering venue by a central authority, a command by telephone, by internet, by mail, a public statement, a private directive, and so on to a local wagering venue to engage in the transaction. For example, such information may include a public pronouncement that the central authority desires an offsetting transactions in a designated jurisdiction (e.g., published on a website). Each of the controlled wagering venues may monitor that website and when their jurisdiction is identified may attempt that transaction. Different forms of ordering may be used in different jurisdictions. Such a method of ordering an action may take a form allowed by a designated jurisdiction. The use of such various methods may allow a single central authority to interact with a variety of wagering venues without violating the laws of the various jurisdictions in which those venues are situated.

Such various methods of receiving and ordering may be performed in accordance with allowable transmission of information in the variety of jurisdictions. For example, some jurisdictions may only allow communication by mail by public declaration, through websites or otherwise. The central authority may be configured to make transmission and/or receive data in accordance with those requirements to each and from each wagering venue and each wagering venue may be configured to make or receive such transmissions accordingly.

The central authority may receive reports on the outcomes of offsetting transaction attempts and may adjust the risk calculations accordingly. For example, the central authority may receive a report that a n offsetting transaction succeeded and may use that offsetting transaction amount in risk calculations for an event.

The central authority itself may be a wagering venue in a location that allows offsetting transactions through an exchange. The central authority may operate such an exchange. The central authority in such a situation may be the only and/or the main location where offsetting transaction occur for a gaming operator. By running an exchange the gaming operator may have access to a larger amount of liquidity of wagering transactions in one location.

In some embodiments offsetting transactions may be carried out in a variety of wagering venues. For example, a desired offset may be sought through more than one wagering venue. If a partial offset is obtained at one, then the attempt at the other may be lowered accordingly.

It should be recognized that while various examples are given in terms of a desired odds, that some embodiments may include determining any desire regarding any element of any possible wager. It should be recognized that while a consensus may be used in some embodiments, in some embodiments, individual information from one or more wagering venues may be used.

Method 400 may end at block 415. It should be recognized that method 400 is given as an example only and that any alternative methods with more, fewer, alternative, differently ordered, and so on actions may be performed in some embodiments.

It should be recognized that while some examples are given in terms of a sports book, various embodiments may include any desired wagering venue, such as, for example, a remote computer terminal, a mobile gaming device, a casino table, any area of a casino, and so on. It should be recognized that while various example systems are shown and described having certain elements, that in various embodiments, any system with any elements having any functionality may be used. It should be recognized that while various examples of methods having example acts are described that various embodiments may include any method having any acts in any order.

### Tax Examples

Some embodiments may include incorporating tax advantages related to wager risk in determining an action to be taken with risk. For example, in some embodiments one jurisdiction may require taxing wins while another jurisdiction does not require taxing wins. If a risk management application determines that one side of a wager is more likely to be a winning side, it may attempt to place that side's wagers more heavily in a jurisdiction that does not tax such winnings. For example, odds in that jurisdiction may be made more favorable for patrons, wagers on that side may be purchased (e.g., through a wager exchange or from another sportsbook) in that jurisdiction and/or sold in another jurisdiction, and so on.

Some embodiments may include attempting to place losses in a jurisdiction where the losses may be used to offset prior wins or other profits when taxes are due. For example, if one jurisdiction has taken a number of wins and a risk manager determines that a loss on one side is more likely than a win, then the risk manager may control operations at that jurisdiction to take the risk for that side of the wager so that if the loss occurs, the losses may be used to offset prior wins. Such adjustment may be forward looking (e.g., if one jurisdiction is expect to take on future wins then an attempt to offset them with losses now may be made).

Some such determinations may be made based on a comparison of player betting behavior to a desired odds calculation. For example, if a risk manager and/or odds making system determines an odds to be at one level, but betting behavior of players results in a different level (e.g., one that deviates from the expected so that one side is more favored than it should be based on the odds calculation), then a risk manager may determine that bettors are betting incorrectly based on the actual likelihoods of outcomes. The odds offered may deviate from the calculated odds to accommodate betting behavior. This may cause one side to be an expected win and one side to be an expected loss (e.g., in situations where there is a point spread and the point spread is shrunk or grown to attract bettors bets that are more favorable and less favorable than the odds calculations shows they should be maybe offered).

Some embodiments may include choosing a jurisdiction for risk mitigation based on tax treatment being better than another jurisdiction. For example, if two jurisdiction allow laying off of a risk that is desired to be laid off from a third jurisdiction, then the jurisdiction from the two that treats possible wins and/or possible losses with the most beneficial tax treatment may be chosen to actually attempt to offset the risk. If laying off cannot occur (e.g., in some time period) then the second jurisdiction may be used.

It should be recognized that such example use of tax as a method of distributing and/or accounting for risk are given as an example only.

### Minimum Size Examples

Some embodiments may include performing risk calculations and/or actions in response to certain events. For example, risk calculations may be performed in response to a wager being placed. Some embodiments may include making a risk calculation in respond to each and every wager. Some embodiments may include only performing a risk calculation in response to a wager exceeding some threshold. (e.g., amount wagered and/or amount of possible payout). For example, a risk calculation may be performed for a wager over 1000 dollars, 100 dollars, 50 dollars, 10 dollars, 10000 dollars, 1 million dollars, and/or over any desired threshold. By limiting risk calculations to a wager threshold, a risk manager may consume fewer system resources while still maintaining a relatively even risk portfolio.

Some embodiments may include performing a periodic risk calculation. For example, a risk calculations may be performed after some period of time and/or after some number of wagers. Such risk calculations may prevent risk from getting too out of a desired range for too long.

It should be recognized that such examples of risk calculation triggers are given as examples only and that other triggers or timing may be used as desired. For example, some embodiments may include performing a risk calculation both in response to a wager of some threshold risk level and periodically.

The following sections I-X provide a guide to interpreting the present application.

### TERMS

The term “product” means any machine, manufacture and/or composition of matter, unless expressly specified otherwise.

The term “process” means any process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the disclosed invention(s)”, unless expressly specified otherwise.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not necessarily limited to”, unless expressly specified otherwise. Thus, for example, the sentence “the portfolio includes a red widget and a blue widget” means the portfolio includes the red widget and the blue widget, but may include something else.

The term “consisting of” and variations thereof means “including and limited to”, unless expressly specified otherwise. Thus, for example, the sentence “the portfolio consists of a red widget and a blue widget” means the portfolio includes the red widget and the blue widget, but does not include anything else.

The term “compose” and variations thereof means “to make up the constituent parts of, component of or member of”, unless expressly specified otherwise. Thus, for example, the sentence “the red widget and the blue widget compose a portfolio” means the portfolio includes the red widget and the blue widget.

The term “exclusively compose” and variations thereof means “to make up exclusively the constituent parts of, to be the only components of or to be the only members of”, unless expressly specified otherwise. Thus, for example, the sentence “the red widget and the blue widget exclusively compose a portfolio” means the portfolio consists of the red widget and the blue widget, and nothing else.

The terms “a”, “an” and “the” mean “one or more”, unless expressly specified otherwise.

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” describes both “based only on” and “based at least on”. The phrase “based at least on” is equivalent to the phrase “based at least in part on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first such machine has a function and the second such machine has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

Any given numerical range shall include whole and fractions of numbers within the range. For example, the range “1 to 10” shall be interpreted to specifically include whole numbers between 1 and 10 (e.g., 1, 2, 3, 4, . . . 9) and non-whole numbers (e.g., 1.1, 1.2, . . . 1.9).

Where two or more terms or phrases are synonymous (e.g., because of an explicit statement that the terms or phrases are synonymous), instances of one such term/phrase does not mean instances of another such term/phrase must have a different meaning. For example, where a statement renders the meaning of “including” to be synonymous with “including but not limited to”, the mere usage of the phrase “including but not limited to” does not mean that the term “including” means something other than “including but not limited to”.

### II. DETERMINING

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing and the like.

The term “determining” does not imply that mathematical processing must be performed, and does not imply that numerical methods must be used, and does not imply that an algorithm or process is used.

The term “determining” does not imply that any particular device must be used. For example, a computer need not necessarily perform the determining.

### III. FORMS OF SENTENCES

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, article or other product is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device, article or other product is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

### IV. DISCLOSED EXAMPLES AND TERMINOLOGY ARE NOT LIMITING

Neither the Title (set forth at the beginning of the first page of the present application) nor the Abstract (set forth at the end of the present application) is to be taken as limiting in any way as the scope of the disclosed invention(s), is to be used in interpreting the meaning of any claim or is to be used in limiting the scope of any claim. An Abstract has been included in this application merely because an Abstract is required under 37 C.F.R. §1.72(b).

The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not include features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or expressly recited in a claim.

The preambles of the claims that follow recite purposes, benefits and possible uses of the claimed invention only and do not limit the claimed invention.

The present disclosure is not a literal description of all embodiments of the invention(s). Also, the present disclosure is not a listing of features of the invention(s) which must be present in all embodiments.

All disclosed embodiment are not necessarily covered by the claims (even including all pending, amended, issued and canceled claims). In addition, an embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention(s), and does not imply that the illustrated process is preferred.

Although a process may be described as including a plurality of steps, that does not imply that all or any of the steps are preferred, essential or required. Various other embodiments within the scope of the described invention(s) include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. COMPUTING

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

A “processor” means one or more microprocessors, central processing units (CPUs), computing devices, microcontrollers, digital signal processors, or like devices or any combination thereof, regardless of the architecture (e.g., chip-level multiprocessing/multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth □, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

### VI. CONTINUING APPLICATIONS

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application.

Applicants intend to file additional applications to pursue patents for subject matter that has been disclosed and enabled but not claimed in the present application.

### VII 35 U.S.C. §112, PARAGRAPH 6

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. DISCLAIMER

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application shall be prefaced by the phrase “does not include” or by the phrase “cannot perform”.

### IX. INCORPORATION BY REFERENCE

Any patent, patent application or other document referred to herein is incorporated by reference into this patent application as part of the present disclosure, but only for purposes of written description and enablement in accordance with 35 U.S.C. §112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference

Any incorporation by reference does not, in and of itself, imply any endorsement of, ratification of or acquiescence in any statements, opinions, arguments or characterizations contained in any incorporated patent, patent application or other document, unless explicitly specified otherwise in this patent application.

### X. PROSECUTION HISTORY

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

### XI. CARDS

Playing cards have been in existence for many years. Although there are many types of playing cards that are played in many different types of games, the most common type of playing cards consists of 52 cards, divided out into four different suits (namely Spades, Hearts, Diamonds and Clubs) which are printed or indicated on one side or on the face of each card. In the standard deck, each of the four suits of cards consists of 13 cards, numbered either two through ten, or lettered A (Ace), K (King), Q (Queen), or J (Jack), which is also printed or indicated on the face of each card. Each card will thus contain on its face a suit indication along with a number or letter indication. The King, Queen, and Jack usually also include some sort of design on the face of the card, and may be referred to as picture cards. Other types of playing cards are described herein, but it should be recognized that various topics may apply to any, some, and/or all type of playing cards.

In some cases, the 52 card standard playing deck also contains a number of extra cards, sometimes referred to as jokers, that may have some use or meaning depending on the particular game being played with the deck. For example, if a card game includes the jokers, then if a player receives a joker in his “hand” he may use it as any card in the deck. If the player has the ten, jack, queen and king of Spades, along with a joker, the player would use the joker as an Ace of Spades. The player will then have a Royal Flush (ten through Ace of Spades).

Many different games can be played using a standard deck of playing cards. The game being played with the standard deck of cards may include other items, such as game boards, chips, etc., or the game being played may only need the playing card deck itself. In most of the games played using a standard deck of cards, a value is assigned to each card. The value may differ for different games.

Usually, the card value begins with the number two card as the lowest value and increases as the numbers increase through ten, followed in order of increasing value with the Jack, Queen, King and Ace. In some games the Ace may have a lower value than the two, and in games where a particular card is determined to be wild, or have any value, that card may have the greatest value of all. For example, in card games where deuces, or twos, are wild, the player holding a playing card containing a two can use that two as any other card, such that a nine and a two would be the equivalent of two nines.

Further, the four different suits indicated on the cards may have a particular value depending on the game. Under game rules where one suit, i.e., Spades, has more value than another suit, i.e., Hearts, the seven of Spades may have more value than the seven of Hearts.

It is easy to visualize that using the different card quantity and suit values, many different games can be played. In certain games, it is the combination of cards that one player obtains that determines whether or not that player has defeated the other player or players. Usually, the more difficult the combination is to obtain, the more value the combination has, and the player who obtains the more difficult combination (also taking into account the value of the cards) wins the game.

For instance in the game of Poker, each player may ultimately receive five cards. The player who obtains three cards having similar numbers on their face, i.e., the four of Hearts, four of Diamonds and four of Clubs, will defeat the player having only two cards with the same numerical value, i.e., the King of Spades and the King of Hearts. However, the player with five cards that all contain Clubs, commonly known as a flush, will defeat the player with the same three of a kind described above.

In many instances, a standard deck of playing cards is used to create gaming machines. In these gaming machines players insert coins and play certain card games, such as poker, using an imitation of standard playing cards on a video screen, in an attempt to win back more money than they originally inserted into the machine.

Another form of gambling using playing cards utilizes tables, otherwise known as table games. A table uses a table and a dealer, with the players sitting or standing around the table. The players place their bets on the table and the dealer deals the cards to each player. The number of cards dealt, or whether the cards are dealt face up or face down, will depend on the particular table game being played.

Further, an imitation or depiction of a standard playing card is used in many handheld electronic games, such as poker and blackjack, and in many computer games and Internet games. Using a handheld electronic game or a computer terminal that may or may not be connected to the Internet, a player receives the imitation playing cards and plays a card game either against the computer or against other players. Further, many of these games can be played on the computer in combination with gambling.

Also, there are many game shows that are broadcasted on television that use a deck of playing cards in the game play, in which the cards are usually enlarged or shown on a video screen or monitor for easy viewing. In these television game shows, the participants play the card game for prizes or money, usually against each other, with an individual acting as a host overseeing the action.

Also, there are lottery tickets that players purchase and play by “scratching off” an opaque layer to see if they have won money and prizes. The opaque layer prevents the player from knowing the results of the lottery ticket prior to purchasing and scratching off the layer. In some of these lottery tickets, playing cards are used under the opaque layer and the player may need to match a number of similar cards in order to win the prizes or money.

### XII. RULES OF CARD GAMES

### Rules of Poker

In a basic poker game, which is played with a standard 52-card deck, each player is dealt five cards. All five cards in each player's hand are evaluated as a single hand with the presence of various combinations of the cards such as pairs, three-of-a-kind, straight, etc. Determining which combinations prevail over other combinations is done by reference to a table containing a ranking of the combinations. Rankings in most tables are based on the odds of each combination occurring in the player's hand. Regardless of the number of cards in a player's hand, the values assigned to the cards, and the odds, the method of evaluating all five cards in a player's hand remain the same.

Poker is a popular skill-based card game in which players with fully or partially concealed cards make wagers into a central pot. The pot is awarded to the player or players with the best combination of cards or to the player who makes an uncalled bet. Poker can also refer to video poker, a single-player game seen in casinos much like a slot machine, or to other games that use poker hand rankings.

Poker is played in a multitude of variations, but most follow the same basic pattern of play.

The right to deal each hand typically rotates among the players and is marked by a token called a ‘dealer’ button or buck. In a casino, a house dealer handles the cards for each hand, but a button (typically a white plastic disk) is rotated clockwise among the players to indicate a nominal dealer to determine the order of betting.

For each hand, one or more players are required to make forced bets to create an initial stake for which the players will contest. The dealer shuffles the cards, he cuts, and the appropriate number of cards are dealt to the players one at a time. Cards may be dealt either face-up or face-down, depending on the variant of poker being played. After the initial deal, the first of what may be several betting rounds begins. Between rounds, the players' hands develop in some way, often by being dealt additional cards or replacing cards previously dealt. At the end of each round, all bets are gathered into the central pot.

At any time during a betting round, if a player makes a bet, opponents are required to fold, call or raise. If one player bets and no opponents choose to match the bet, the hand ends immediately, the bettor is awarded the pot, no cards are required to be shown, and the next hand begins. The ability to win a pot without showing a hand makes bluffing possible. Bluffing is a primary feature of poker, one that distinguishes it from other vying games and from other games that make use of poker hand rankings.

At the end of the last betting round, if more than one player remains, there is a showdown, in which the players reveal their previously hidden cards and evaluate their hands. The player with the best hand according to the poker variant being played wins the pot.

The most popular poker variants are as follows:

Draw Poker

Players each receive five—as in five-card draw—or more cards, all of which are hidden. They can then replace one or more of these cards a certain number of times.

Stud Poker

Players receive cards one at a time, some being displayed to other players at the table. The key difference between stud and ‘draw’ poker is that players are not allowed to discard or replace any cards.

Community Card Poker

Players combine individually dealt cards with a number of “community cards” dealt face up and shared by all players. Two or four individual cards may be dealt in the most popular variations, Texas hold 'em and Omaha hold 'em, respectively.

Poker Hand Rankings

Straight Flush

A straight flush is a poker hand such as Q [symbol] J [symbol] 10 [symbol] 9 [symbol] 8 [symbol] , which contains five cards in sequence, all of the same suit. Two such hands are compared by their high card in the same way as are straights. The low ace rule also applies: 5♦ 4♦ 3♦ 2♦ A♦ is a 5-high straight flush (also known as a “steel wheel”). An ace-high straight flush such as A [symbol] K [symbol] Q [symbol] J [symbol] 10 [symbol] is known as a royal flush, and is the highest ranking standard poker hand (excluding five of a kind).

### Examples

7♡ 6♡ 5♡ 4♡ 3♡ beats 5 [symbol] 4 [symbol] 3 [symbol] 2 [symbol] A

[symbol]

J [symbol] 10 [symbol] 9 [symbol] 8 [symbol] 7 [symbol] ties J♦ 10♦ 9♦ 8♦ 7♦

Four of a Kind

Four of a kind, or quads, is a poker hand such as 9 [symbol] 9 [symbol] 9♦ 9♡ J♡, which contains four cards of one rank, and an unmatched card. It ranks above a full house and below a straight flush. Higher ranking quads defeat lower ranking ones. Between two equal sets of four of a kind (possible in wild card and community card games), the kicker determines the winner.

### Examples

10 [symbol] 10♦ 10♡ 10 [symbol] 5♦ (“four tens” or “quad tens”) defeats 6♦ 6♡ 6 [symbol] 6 [symbol] K [symbol] (“four sixes” or “quad sixes”)

10 [symbol] 10♦ 10♦ 10 [symbol] Q [symbol] (“four tens, queen kicker”) defeats 10 [symbol] 10♦ 10♡ 10 [symbol] 5♦ (“four tens with a five”)

Full House

A full house, also known as a boat or a full boat, is a poker hand such as 3 [symbol] 3 [symbol] 3♦ 6 [symbol] 6♡, which contains three matching cards of one rank, plus two matching cards of another rank. It ranks below a four of a kind and above a flush. Between two full houses, the one with the higher ranking set of three wins. If two have the same set of three (possible in wild card and community card games), the hand with the higher pair wins. Full houses are described by the three of a kind (e.g. Q-Q-Q) and pair (e.g. 9-9), as in “Queens over nines” (also used to describe a two pair), “Queens full of nines” or simply “Queens full”.

### Examples

10 [symbol] 10♡ 10♦ 4 [symbol] 4♦ (“tens full”) defeats 9♡ 9 [symbol] 9 [symbol] A♡ A [symbol] (“nines full”)

K [symbol] K [symbol] K♡ 3♦ 3 [symbol] (“kings full”) defeats 3 [symbol] 3♡ 3♦ K [symbol] K♦ (“threes full”)

Q♡ Q♦ Q [symbol] 8♡ 8 [symbol] (“queens full of eights”) defeats Q♡ Q♦ Q [symbol] 5 [symbol] 5♡ (“queens full of fives”)

Flush

A flush is a poker hand such as Q [symbol] 10 [symbol] 7 [symbol] 6 [symbol] 4 [symbol] , which contains five cards of the same suit, not in rank sequence. It ranks above a straight and below a full house. Two flushes are compared as if they were high card hands. In other words, the highest ranking card of each is compared to determine the winner; if both have the same high card, then the second-highest ranking card is compared, etc. The suits have no value: two flushes with the same five ranks of cards are tied. Flushes are described by the highest card, as in “queen-high flush”.

### Examples

A♡ Q♡ 10♡ 5♡ 3♡ (“ace-high flush”) defeats K [symbol] Q [symbol] J [symbol] 9 [symbol] 6 [symbol] (“king-high flush”)

A♦ K♦ 7♦ 6♦ 2♦ (“flush, ace-king high”) defeats A♡ Q♡ 10♡ 5♡ 3♡ (“flush, ace-queen high”)

Q♡ 10♡ 9♡ 5♡ 2♡ (“heart flush”) ties Q [symbol] 10 [symbol] 9 [symbol] 5 [symbol] 2 [symbol] (“spade flush”)

Straight

A straight is a poker hand such as Q [symbol] J [symbol] 10 [symbol] 9♡ 8♡, which contains five cards of sequential rank, of varying suits. It ranks above three of a kind and below a flush. Two straights are ranked by comparing the high card of each. Two straights with the same high card are of equal value, and split any winnings (straights are the most commonly tied hands in poker, especially in community card games). Straights are described by the highest card, as in “queen-high straight” or “straight to the queen”.

A hand such as A [symbol] K [symbol] Q♦ J [symbol] 10 [symbol] is an ace-high straight, and ranks above a king-high straight such as K♡ Q [symbol] J♡ 10♡ 9♦. But the ace may also be played as a 1-spot in a hand such as 5 [symbol] 4♦ 3♦ 2 [symbol] A [symbol] , called a wheel or five-high straight, which ranks below the six-high straight 6 [symbol] 5 [symbol] 4 [symbol] 3♡ 2♡. The ace may not “wrap around”, or play both high and low in the same hand: 3 [symbol] 2♦ A [symbol] K [symbol] Q [symbol] is not a straight, but just ace-high no pair.

### Examples

8 [symbol] 7 [symbol] 6♡ 5♡ 4 [symbol] (“eight-high straight”) defeats 6♦ 5 [symbol] 4♦ 3♡ 2 [symbol] (“six-high straight”)

8 [symbol] 7 [symbol] 6♡ 5♡ 4 [symbol] ties 8♡ 7♦ 6 [symbol] 5 [symbol] 4♡

Three of a Kind

Three of a kind, also called trips, set or a prile, is a poker hand such as 2♦ 2 [symbol] 2♡ K [symbol] 6 [symbol] , which contains three cards of the same rank, plus two unmatched cards. It ranks above two pair and below a straight. Higher ranking three of a kind defeat lower ranking three of a kinds. If two hands have the same rank three of a kind (possible in games with wild cards or community cards), the kickers are compared to break the tie.

### Examples

8 [symbol] 8♡ 8♦ 5 [symbol] 3 [symbol] (“three eights”) defeats 5 [symbol] 5♡ 5♦ Q♦ 10 [symbol] (“three fives”)

8 [symbol] 8♡ 8♦ A [symbol] 2♦ (“three eights, ace kicker”) defeats 8 [symbol] 8♡ 8♦ 5 [symbol] 3 [symbol] (“three eights, five kicker”)

Two Pair

A poker hand such as J♡ J [symbol] 4 [symbol] 4 [symbol] 9 [symbol] , which contains two cards of the same rank, plus two cards of another rank (that match each other but not the first pair), plus one unmatched card, is called two pair. It ranks above one pair and below three of a kind. Between two hands containing two pair, the higher ranking pair of each is first compared, and the higher pair wins. If both have the same top pair, then the second pair of each is compared. Finally, if both hands have the same two pairs, the kicker determines the winner. Two pair are described by the higher pair (e.g., K♡ K [symbol] ) and the lower pair (e.g., 9 [symbol] 9♦), as in “Kings over nines”, “Kings and nines” or simply “Kings up”.

### Examples

K♡ K♦ 2 [symbol] 2♦ J♡ (“kings up”) defeats J♦ J [symbol] 10 [symbol] 10 [symbol] 9 [symbol] (“jacks up”)

9 [symbol] 9♦ 7♦ 7 [symbol] 6♡ (“nines and sevens”) defeats 9♡ 9 [symbol] 5♡ 5♦ K [symbol] (“nines and fives”)

4 [symbol] 4 [symbol] 3 [symbol] 3♡ K♦ (“fours and threes, king kicker”) defeats 4♡ 4♦ 3♦ 3 10 [symbol] (“fours and threes with a ten”)

One Pair

One pair is a poker hand such as 4♡ 4 [symbol] K [symbol] 10♦ 5 [symbol] , which contains two cards of the same rank, plus three unmatched cards. It ranks above any high card hand, but below all other poker hands. Higher ranking pairs defeat lower ranking pairs. If two hands have the same rank of pair, the non-paired cards in each hand (the kickers) are compared to determine the winner.

### Examples

10 [symbol] 10 [symbol] 6 [symbol] 4♡ 2♡ (“pair of tens”) defeats 9♡ 9 [symbol] A♡ Q♦ 10♦ (“pair of nines”)

10♡ 10♦ J♦ 3♡ 2 [symbol] (“tens with jack kicker”) defeats 10 [symbol] 10 [symbol] 6 [symbol] 4♡ 2♡ (“tens with six kicker”)

2♦ 2♡ 8 [symbol] 5 [symbol] 4 [symbol] (“deuces, eight-five-four”) defeats 2 [symbol] 2 [symbol] 8 [symbol] 5♡ 3♡ (“deuces, eight-five-three”)

High Card

A high-card or no-pair hand is a poker hand such as K♡ J [symbol] 8 [symbol] 7♦ 3 [symbol] , in which no two cards have the same rank, the five cards are not in sequence, and the five cards are not all the same suit. It can also be referred to as “nothing” or “garbage,” and many other derogatory terms. It ranks below all other poker hands. Two such hands are ranked by comparing the highest ranking card; if those are equal, then the next highest ranking card; if those are equal, then the third highest ranking card, etc. No-pair hands are described by the one or two highest cards in the hand, such as “king high” or “ace-queen high”, or by as many cards as are necessary to break a tie.

### Examples

A♦ 10♦ 9 [symbol] 5 [symbol] 4 [symbol] (“ace high”) defeats K [symbol] Q♦ J [symbol] 8♡ 7♡ (“king high”)

A [symbol] Q [symbol] 7♦ 5♡ 2 [symbol] (“ace-queen”) defeats A♦ 10♦ [symbol] 5 [symbol] 4 [symbol] (“ace-ten”)

7 [symbol] 6 [symbol] 5 [symbol] 4♦ 2♡ (“seven-six-five-four”) defeats 7 [symbol] 6♦ 5♦ 3♡ 2 [symbol] (“seven-six-five-three”)

Decks Using a Bug

The use of joker as a bug creates a slight variation of game play. When a joker is introduced in standard poker games it functions as a fifth ace, or can be used as a flush or straight card (though it can be used as a wild card too). Normally casino draw poker variants use a joker, and thus the best possible hand is five of a kind, as in A♡ A♦ A [symbol] A [symbol] Joker.

Rules of Caribbean Stud

Caribbean Stud™ poker may be played as follows. A player and a dealer are each dealt five cards. If the dealer has a poker hand having a value less than Ace-King combination or better, the player automatically wins. If the dealer has a poker hand having a value of an Ace-King combination or better, then the higher of the player's or the dealer's hand wins. If the player wins, he may receive an additional bonus payment depending on the poker rank of his hand. In the commercial play of the game, a side bet is usually required to allow a chance at a progressive jackpot. In Caribbean Stud™ poker, it is the dealer's hand that may qualify. As the dealer's hand is partially concealed during play (usually only one card, at most) is displayed to the player before player wagering is complete), the player may always be aware that even ranked player hands can lose to a dealer's hand and no bonus will be paid out unless the side bet has been made, and then usually only to hands having a rank of a flush or higher.

### Rules of Blackjack

Some versions of Blackjack are now described. Blackjack hands are scored according to the point total of the cards in the hand. The hand with the highest total wins as long as it is 21 or less. If the total is greater than 21, it is a called a “bust.” Numbered cards 2 through 10 have a point value equal to their face value, and face cards (i.e., Jack, Queen and King) are worth 10 points. An Ace is worth 11 points unless it would bust a hand, in which case it is worth 1 point. Players play against the dealer and win by having a higher point total no greater than 21. If the player busts, the player loses, even if the dealer also busts. If the player and dealer have hands with the same point value, this is called a “push,” and neither party wins the hand.

After the initial bets are placed, the dealer deals the cards, either from one or more, but typically two, hand-held decks of cards, or from a “shoe” containing multiple decks of cards, generally at least four decks of cards, and typically many more. A game in which the deck or decks of cards are hand-held is known as a “pitch” game. “Pitch” games are generally not played in casinos. When playing with more than one deck, the decks are shuffled together in order to make it more difficult to remember which cards have been dealt and which have not. The dealer deals two cards to each player and to himself. Typically, one of the dealer's two cards is dealt face-up so that all players can see it, and the other is face down. The face-down card is called the “hole card.” In a European variation, the “hole card” is dealt after all the players’ cards are dealt and their hands have been played. The players' cards are dealt face up from a shoe and face down if it is a “pitch” game.

A two-card hand with a point value of 21 (i.e., an Ace and a face card or a 10) is called a “Blackjack” or a “natural” and wins automatically. A player with a “natural” is conventionally paid 3:2 on his bet, although in 2003 some Las Vegas casinos began paying 6:5, typically in games with only a single deck.

Once the first two cards have been dealt to each player and the dealer, the dealer wins automatically if the dealer has a “natural” and the player does not. If the player has a “natural” and the dealer does not, the player automatically wins. If the dealer and player both have a “natural,” neither party wins the hand.

If neither side has a “natural,” each player completely plays out their hand; when all players have finished, the dealer plays his hand.

The playing of the hand typically involves a combination of four possible actions “hitting,” “standing,” “doubling down,” or “splitting” his hand. Often another action called “surrendering” is added. To “hit” is to take another card. To “stand” is to take no more cards. To “double down” is to double the wager, take precisely one more card and then “stand.” When a player has identical value cards, such as a pair of 8s, the player can “split” by placing an additional wager and playing each card as the first card in two new hands. To “surrender” is to forfeit half the player's bet and give up his hand. “Surrender” is not an option in most casino games of Blackjack. A player's turn ends if he “stands,” “busts” or “doubles down.” If the player “busts,” he loses even if the dealer subsequently busts. This is the house advantage.

After all players have played their hands, the dealer then reveals the dealer's hole card and plays his hand. According to house rules (the prevalent casino rules), the dealer may hit until he has a point total of at least 17, regardless of what the players have. In most casinos, the dealer may also hit on a “soft” 17 (e.g., an Ace and 6). In a casino, the Blackjack table felt is marked to indicate if the dealer hits or stands on a soft 17. If the dealer busts, all remaining players win. Bets are normally paid out at odds of 1:1.

Four of the common rule variations are one card split Aces, early surrender, late surrender and double-down restrictions. In the first variation, one card is dealt on each Ace and the player's turn is over. In the second, the player has the option to surrender before the dealer checks for Blackjack. In the third, the player has the option to surrender after the dealer checks for Blackjack. In the fourth, doubling-down is only permitted for certain card combinations.

### Insurance

Insurance is a commonly-offered betting option in which the player can hedge his bet by wagering that the dealer will win the hand. If the dealer's “up card” is an Ace, the player is offered the option of buying Insurance before the dealer checks his “hole card.” If the player wishes to take Insurance, the player can bet an amount up to half that of his original bet. The Insurance bet is placed separately on a special portion of the table, which is usually marked with the words “Insurance Pays 2:1.” The player buying Insurance is betting that the dealer's “hole card” is one with a value of 10 (i.e., a 10, Jack, Queen or King). Because the dealer's up card is an Ace, the player who buys Insurance is betting that the dealer has a “natural.”

If the player originally bets $10 and the dealer shows an Ace, the player can buy Insurance by betting up to $5. Suppose the player makes a $5 Insurance bet and the player's hand with the two cards dealt to him totals 19. If the dealer's hole card is revealed to be a 10 after the Insurance betting period is over (the dealer checks for a “natural” before the players play their hands), the player loses his original $10 bet, but he wins the $5 Insurance bet at odds of 2:1, winning $10 and therefore breaking even. In the same situation, if the dealer's hole card is not one with a value of ten, the player immediately loses his $5 Insurance bet. But if the player chooses to stand on 19, and if the dealer's hand has a total value less than 19, at the end of the dealer's turn, the player wins his original $10 bet, making a net profit of $5. In the same situation, if the dealer's hole card is not one with a value of ten, again the player will immediately lose their $5 Insurance bet, and if the dealer's hand has a total value greater than the player's at the end of both of their turns, for example the player stood on 19 and the dealer ended his turn with 20, the player loses both his original $10 bet and his $5 Insurance bet.

### Basic Strategy

Blackjack players can increase their expected winnings by several means, one of which is “basic strategy.” “Basic strategy” is simply something that exists as a matter of general practice; it has no official sanction. The “basic strategy” determines when to hit and when to stand, as well as when doubling down or splitting in the best course. Basic strategy is based on the player's point total and the dealer's visible card. Under some conditions (e.g., playing with a single deck according to downtown Las Vegas rules) the house advantage over a player using basic strategy can be as low as 0.16%. Casinos offering options like surrender and double-after-split may be giving the player using basic strategy a statistical advantage and instead rely on players making mistakes to provide a house advantage.

A number of optional rules can benefit a skilled player, for example: if doubling down is permitted on any two-card hand other than a natural; if “doubling down” is permitted after splitting; if early surrender (forfeiting half the bet against a face or Ace up card before the dealer checks for Blackjack) is permitted; if late surrender is permitted; if re-splitting Aces is permitted (splitting when the player has more than two cards in their hand, and has just been dealt a second ace in their hand); if drawing more than one card against a split Ace is permitted; if five or more cards with a total no more than 21 is an automatic win (referred to as “Charlies”).

Other optional rules can be detrimental to a skilled player. For example: if a “natural” pays less than 3:2 (e.g., Las Vegas Strip single-deck Blackjack paying out at 6:5 for a “natural”); if a hand can only be split once (is re-splitting possible for other than aces); if doubling down is restricted to certain totals (e.g., 9 11 or 10 11); if Aces may not be re-split; if the rules are those of “no-peek” (or European) Blackjack, according to which the player loses hands that have been split or “doubled down” to a dealer who has a “natural` (because the dealer does not check for this automatically winning hand until the players had played their hands); if the player loses ties with the dealer, instead of pushing where neither the player or the dealer wins and the player retains their original bet.

### Card Counting

Unlike some other casino games, in which one play has no influence on any subsequent play, a hand of Blackjack removes those cards from the deck. As cards are removed from the deck, the probability of each of the remaining cards being dealt is altered (and dealing the same cards becomes impossible). If the remaining cards have an elevated proportion of 10-value cards and Aces, the player is more likely to be dealt a natural, which is to the player's advantage (because the dealer wins even money when the dealer has a natural, while the player wins at odds of 3:2 when the player has a natural). If the remaining cards have an elevated proportion of low-value cards, such as 4s, 5s and 6s, the player is more likely to bust, which is to the dealer's advantage (because if the player busts, the dealer wins even if the dealer later busts).

The house advantage in Blackjack is relatively small at the outset. By keeping track of which cards have been dealt, a player can take advantage of the changing proportions of the remaining cards by betting higher amounts when there is an elevated proportion of 10-value cards and Aces and by better lower amounts when there is an elevated proportion of low-value cards. Over time, the deck will be unfavorable to the player more often than it is favorable, but by adjusting the amounts that he bets, the player can overcome that inherent disadvantage. The player can also use this information to refine basic strategy. For instance, basic strategy calls for hitting on a 16 when the dealer's up card is a 10, but if the player knows that the deck has a disproportionately small number of low-value cards remaining, the odds may be altered in favor of standing on the 16.

There are a number of card-counting schemes, all dependent for their efficacy on the player's ability to remember either a simplified or detailed tally of the cards that have been played. The more detailed the tally, the more accurate it is, but the harder it is to remember. Although card counting is not illegal, casinos will eject or ban successful card counters if they are detected.

Shuffle tracking is a more obscure, and difficult, method of attempting to shift the odds in favor of the player. The player attempts to track groups of cards during the play of a multi-deck shoe, follow them through the shuffle, and then looks for the same group to reappear from the new shoe, playing and betting accordingly.

### XIII. TRACKING THE ACTION AT A TABLE

U.S. Pat. No. 6,579,181 generally describes, “a system for automatically monitoring playing and wagering of a game. In one illustrated embodiment, the system includes a card deck reader that automatically reads a respective symbol from each card in a deck of cards before a first one of the cards is removed from the deck. The symbol identifies a value of the card in terms of rank and suit, and can take the form of a machine-readable symbol, such as a bar code, area or matrix code or stacked code. In another aspect, the system does not decode the read symbol until the respective card is dealt, to ensure security.

“In another aspect, the system can include a chip tray reader that automatically images the contents of a chip tray. The system periodically determines the number and value of chips in the chip tray from the image, and compares the change in contents of the chip tray to the outcome of game play to verify that the proper amounts have been paid out and collected.

“In a further aspect, the system can include a table monitor that automatically images the activity or events occurring at a gaming table. The system periodically compares images of the gaming table to identify wagering, as well as the appearance, removal and position of cards and/or other objects on the gaming table. The table monitoring system can be unobtrusively located in the chip tray.”

U.S. Pat. No. 6,579,181 generally describes “a drop box that automatically verifies an amount and authenticity of a deposit and reconciles the deposit with a change in the contents of the chip tray. The drop box can image different portions of the deposited item, selecting appropriate lighting and resolutions to examine security features in the deposited item.

“In another aspect, the system can employ some, or all of the components to monitor the gaming habits of players and the performance of employees. The system can detect suspect playing and wagering patterns that may be prohibited. The system can also identify the win/loss percentage of the players and the dealer, as well as a number of other statistically relevant measures. Such measures can provide a casino or other gaming establishment with enhanced automated security, and automated real-time accounting. The measures can additionally provide a basis for automatically allocating complimentary benefits to the players.”

Various embodiments include an apparatus, method and system which utilizes a card dispensing shoe with scanner and its associated software which enable the card dealer when dealing the game from a card dispensing shoe with scanner preferably placed on a game table where the twenty-one game to be evaluated by the software is being played, to use one or more keyboard(s) and/or LCD displays coupled to the shoe to identify for the computer program the number of the active players' seats, or active players, including the dealer's position relative thereto and their active play at the game table during each game round dealt from the shoe. These keyboards and LCD displays are also used to enter other data relevant to each seat's, or player's, betting and/or decision strategies for each hand played. The data is analyzed by a computer software program designed to evaluate the strategy decisions and betting skills of casino twenty-one, or blackjack players playing the game of blackjack during real time. The evaluation software is coupled to a central processing unit (CPU) or host computer that is also coupled to the shoe's keyboard(s) and LCD displays. The dealer using one or more keyboard(s) attached to or carried by the shoe, or a keyboard(s) located near the dealer is able to see and record the exact amount bet by each player for each hand played for the game to be evaluated. The optical scanner coupled to the CPU reads the value of each card dealt to each player's hand(s) and the dealer's hand as each card is dealt to a specific hand, seat or position and converts the game card value of each card dealt from the shoe to the players and the dealer of the game to a card count system value for one or more card count systems programmed into the evaluation software. The CPU also records each players decision(s) to hit a hand, and the dealer's decision to hit or take another card when required by the rules of the game, as the hit card is removed from the shoe. The dealer uses one or more of the keyboards and LCD displays carried by the shoe to record each player's decision(s) to Insure, Surrender, Stand, Double Down, or Split a hand. When the dealer has an Ace or a Ten as an up-card, he/she may use one or more of the keyboards to prompt the computer system's software, since the dealer's second card, or hole-card, which is dealt face down, has been scanned and the game card value thereof has been imported into the computer systems software, to instantly inform the dealer, by means of one or more of the shoe's LCDs, if his/her game cards, or hand total, constitutes a two-card “21” or “Blackjack”.

In various embodiments, a card playing system for playing a card game which includes a card delivery shoe apparatus for use in dealing playing cards to at least one player for the playing of the card game comprises, in combination, housing means having a chute for supporting at least one deck of playing cards for permitting movement of the playing cards one at a time through the chute, the housing means having an outlet opening that permits the playing cards of the deck to be moved one-by-one out of the housing means during the play of a card game, card scanning means located within the housing means for scanning indicia located on each of the playing cards as each of the playing cards are moved out from the chute of the housing means, means for receiving the output of the card scanning means for identifying each of the playing cards received by each player from the shoe, for evaluating information relative to each players received playing cards and their values with information as to playing tactics used by each player relative to the values of the received playing cards, and for combining all of this information for identifying each player's playing strategy, and a playing table coupled to the card delivery shoe apparatus and having at least one keypad means located thereon for permitting at least one player to select various card playing options to wager upon.

In various embodiments, a card playing system for playing a card game which includes a card delivery shoe apparatus for use in dealing playing cards to at least one player for the playing of the card game comprises, in combination, housing means having a chute for supporting at least one deck of playing cards for permitting movement of the playing cards one at a time through the chute, the housing means having an outlet opening that permits the playing cards of the deck to be moved one-by-one out of the housing means during the play of a card game, card scanning means located within the housing means for scanning indicia located on each of the playing cards as each of the playing cards are moved out from the chute of the housing means, means for receiving the output of the card scanning means for identifying such of the playing cards received by each player from the shoe apparatus, for evaluating information relative to each player's received playing cards and their values with information as to betting tactics used by each player relative to playing cards previously dealt out from the shoe apparatus providing card count information, and for combining all of this information for identifying each player's card count strategy, and a playing table coupled to the card delivery shoe apparatus and having at least one keypad means located thereon for permitting the at least one player to select at least one of various card playing options to wager upon.

In various embodiments, a card playing system for playing a card game which includes a card delivery shoe apparatus for use in dealing playing cards to at least one player for the playing of a card game comprises, in combination, housing means having a chute for supporting at least one deck of playing cards for permitting movement of the playing cards one at a time through the chute, the housing means having an outlet opening that permits the playing cards of the deck to be moved one-by-one out of the housing means during the play of a card game, card scanning means located within the housing means for scanning indicia located on each of the playing cards as each of the playing cards are moved out from the chute of the housing means, means for receiving the output of the card scanning means for identifying each of the playing cards received by each player from the shoe apparatus, for evaluating information relative to each player's received playing cards and their values with information as to playing tactics used by each player relative to the values of the received playing cards, for combining use of all of this information for identifying each player's playing strategy, and for also identifying each player's card count strategy based on each player's betting tactics used by each player relative to playing cards previously dealt out from the shoe apparatus providing card count information, and a playing table coupled to the card delivery shoe apparatus and having at least one keypad means located thereon for permitting the at least one player to select at least one of various card playing options to wager upon.

In various embodiments, a secure game table system, adapted for multiple sites under a central control, allows for the monitoring of hands in a progressive live card game. A live card game has at least one deck, with each deck having a predetermined number of cards. Each game table in the system has a plurality of player positions with or without players at each position and a dealer at a dealer position.

In one embodiment, for providing additional security, a common identity code is located on each of the cards in each deck. Each deck has a different common identity code. A shuffler is used to shuffle the decks together and the shuffler has a circuit for counting of the cards from a previous hand that are inserted into the shuffler for reshuffling. The shuffler circuit counts each card inserted and reads the common identity code located on each card. The shuffler circuit issues a signal corresponding to the count and the common identity code read. The game control (e.g., the computer) located at each table receives this signal from the shuffler circuit and verifies that no cards have been withdrawn from the hand by a player (or the dealer) or that no new cards have been substituted. If the count is not proper or if a game card lacks an identity code or an identity code is mismatched, an alarm signal is generated indicating that a new deck of cards needs to be used and that the possibility of a breach in the security of the game has occurred.

In yet another embodiment of security, a unique code, such as a bar code, is placed on each card and as each card is dealt by the dealer from a shoe, a detector reads the code and issues a signal to the game control containing at least the value and the suit of each card dealt in the hand. The detector may also read a common identity deck code and issue that as a signal to the game control. The shoe may have an optical scanner for generating an image of each card as it is dealt from the shoe by the dealer in a hand. The game control stores this information in a memory so that a history of each card dealt from the shoe in a hand is recorded.

In yet another embodiment of security, an integrated shuffler/shoe obtains an optical image of each card dealt from the shoe for a hand and for each card inserted into the shuffler after a hand. These images are delivered to the game control where the images are counted and compared. When an irregular count or comparison occurs, an alarm is raised. The shuffler and shoe are integrated to provide security between the two units.

In another embodiment of security for a live card game, a game bet sensor is located near each of the plurality of player positions for sensing the presence of a game bet. The game bet sensor issues a signal counting the tokens placed. It is entirely possible that game bet sensors at some player positions do not have bets, and therefore, the game control that is receptive of these signals identifies which player positions have players placing game bets. This information is stored in memory and becomes part of the history of the game.

In another embodiment of security, a progressive bet sensor is located at each of the plurality of player positions and senses the presence of a progressive bet. The progressive bet sensor issues a signal that is received by the game control, which records in memory the progressive bets being placed at the respective player position sensed. If a progressive bet is sensed and a game bet is not, the game control issues an alarm signal indicating improper betting. At this point, the game control knows the identity of each player location having placed a game bet and, of those player positions having game bets placed, which player positions also have a progressive bet. This is stored in memory as part of the history of the hand.

In yet another embodiment of security, a card sensor is located near each player position and the dealer position. The card sensor issues a signal for each card received at the card sensor. The game control receives this issued signal and correlates those player positions having placed a game bet with the received cards. In the event a player position without a game bet receives a card or a player position with a game bet receives a card out of sequence, the game control issues an alarm. This information is added to the history of the game in memory, and the history contains the value and suit of each card delivered to each player position having a game bet.

A progressive jackpot display may be located at each game table and may display one or more jackpot awards for one or more winning combinations of cards. In one embodiment of the present invention, the game control at each table has stored in memory the winning combinations necessary to win the progressive jackpots. Since the game control accurately stores the suit and value of each card received at a particular player position, the game control can automatically detect a winning combination and issue an award signal for that player position. The dealer can then verify that that player at that position indeed has the correct combination of cards. The game control continuously updates the central control interconnected to all other game tables so that the central control can then inform all game tables of this win including, if desirable, the name of the winner and the amount won.

The central control communicates continuously with each game control and its associated progressive jackpot display may receive over a communication link all or part of the information stored in each game control.

Various embodiments include a card shoe with a device for automatic recognition and tracking of the value of each gaming card drawn out of the card shoe in a covered way (face down).

Various embodiments include a gaming table with a device for automatic recognition of played or not played boxes (hands), whereby it has to realize multiple bets on each hand and the use of insurance lines. Furthermore, the gaming table may include a device to recognize automatically the number of cards placed in front of each player and the dealer.

Various embodiments include the recognition, tracking, and storage of gaming chips.

In various embodiment, an electronic data processing (EDP) program may process the value of all bets on each box and associated insurance line, control the sequence of delivery of the cards, control the distribution of the gaming cards to each player and the dealer, may calculate and compare the total score of each hand and the dealer's, and may evaluate the players' wins.

Gaming data may then be processed by means of the EDP program and shown simultaneously to the actual game at a special monitor or display. Same data may be recalled later on to monitor the total results whenever requested.

Various embodiments include a gaming table and a gaming table cloth arranged on the gaming table, the gaming table cloth provided with betting boxes and areas designated for placement of the gaming chips and other areas designated for placement of the playing cards, a card shoe for storage of one or more decks of playing cards, this card shoe including means for drawing individual ones of the playing cards face down so that a card value imprint on the drawn card is not visible to a player of the game of chance, a card recognition means for recognizing this card value imprint on the drawn card from the card shoe, this card recognition means being located in the card shoe, an occupation detector unit including means for registering a count of gaming chips placed on the designated areas and another count of playing cards placed on the other designated areas on the table cloth, this occupation detector unit being located under the table cloth and consisting of multiple single detectors allocated to each betting box, each area for chips and each other area for playing cards respectively, a gaming bet detector for automatic recognition or manual input of gaming bets, and a computer including means for evaluating the play of the game of chance according to the rules of the game of chance, means for storing results of the play of the game of chance and means for displaying a course of the play of the game of chance and the results from electronic signals input from the gaming bet detector, the occupation detector unit and the card recognition means.

According to various embodiments, the card recognition means comprises an optical window arranged along a movement path of the card image imprint on the playing card drawn from the card shoe; a pulsed light source for illuminating a portion of the drawn playing card located opposite the optical window; a CCD image converter for the portion of the drawn playing card located opposite the optical window; an optical device for deflecting and transmitting a reflected image of the card value imprint from the drawn playing card to the CCD image converter from that portion of the drawn playing card when the drawn card is exactly in a correct drawn position opposite the optical window; and sensor means for detecting movement of the drawn card and for providing a correct timing for operation of the pulsed light source for transmission of the reflected image to the CCD image converter. The optical device for deflecting and transmitting the reflected image can comprise a minor arranged to deflect the reflected image to the CCD image converter. Alternatively, the optical device for deflecting and transmitting the reflected image comprises a reflecting optical prism having two plane surfaces arranged at right angles to each other, one of which covers the optical window and another of which faces the CCD image converter and comprises a minor, and the pulsed light source is arranged behind the latter plane surface so as to illuminate the drawn card when the drawn card is positioned over the optical window. Advantageously the sensor means for detecting movement of the drawn card and for providing a correct timing comprises a single sensor, preferably either a pressure sensor or a photoelectric threshold device, for sensing a front edge of the drawn card to determine whether or not the drawn card is being drawn and to activate the CCD image converter and the pulsed light source when a back edge of the drawn card passes the sensor means. Alternatively, the sensor means can include two electro-optical sensors, one of which is located beyond a movement path of the card image imprint on the drawn playing card and another of which is located in a movement path of the card image imprint on a drawn playing card. The latter electro-optical sensor can includes means for activating the pulsed light source by sensing a color trigger when the card value imprint passes over the optical window. In preferred embodiments of the card shoe the pulsed light source comprises a Xenon lamp.

In various embodiments of the gaming apparatus the single detectors of the occupation detector unit each comprise a light sensitive sensor for detection of chips or playing cards arranged on the table cloth over the respective single detector. Each single detector can be an infrared sensitive photodiode, preferably a silicon photodiode. Advantageously the single detectors can be arranged in the occupation detector unit so that the chips or playing cards placed over them on the table cloth are arrange over at least two single detectors.

The gaming apparatus may includes automatic means for discriminating colored markings or regions on the chips and for producing a bet output signal in accordance with the colored markings or regions and the number of chips having identical colored markings or regions.

The gaming bet detector may include automatic means for discriminating between chips of different value in the game of chance and means for producing a bet output signal in accordance with the different values of the chips when the chips are bet by a player. In various embodiments the gaming bet detector includes a radio frequency transmitting and receiving station and the chips are each provided with a transponder responding to the transmitting and receiving station so that the transponder transmits the values of the bet chips back to the transmitting and receiving station.

The connection between the individual units of the gaming apparatus and the computer can be either a wireless connection or a cable connection.

### XIV. FOLLOWING THE BETS

Various embodiments include a smart card delivery shoe that reads the suit and rank of each card before it is delivered to the various positions where cards are to be dealt in the play of the casino table card game. The cards are then dealt according to the rules of the game to the required card positions. Different games have diverse card distribution positions, different card numbers, and different delivery sequences that the hand identifying system of some embodiments of the invention may encompass. For example, in the most complex of card distribution games of blackjack, cards are usually dealt one at a time in sequence around a table, one card at a time to each player position and then to the dealer position. The one card at a time delivery sequence is again repeated so that each player position and the dealer position have an initial hand of exactly two cards. Complexity in hand development is introduced because players have essentially unlimited control over additional cards until point value in a hand exceeds a count of twenty-one. Players may stand with a count of 2 (two aces) or take a hit with a count of 21 if they are so inclined, so the knowledge of the count of a hand is no assurance of what a player will do. The dealer, on the other hand, is required to follow strict house rules on the play of the game according to the value of the dealer's hand. Small variances such as allowing or disallowing a hit on a “soft” seventeen count (e.g., an Ace and a 6) may exist, but the rules are otherwise very precise so that the house or dealer cannot exercise any strategy.

Other cards games may provide equal numbers of cards in batches. Variants of stud poker played against a dealer, for example, would usually provide hands of five cards, five at a time to each player position and if competing against a dealer, to the dealer position. This card hand distribution is quite simple to track as each sequence of five cards removed from the dealer shoe is a hand.

Other games may require cards to be dealt to players and other cards dealt to a flop or common card area. The system may also be programmable to cover this alternative if it is so desired.

Baccarat is closer to blackjack in card sequence of dealing, but has more rigid rules as to when hits may be taken by the player and the dealer, and each position may take a maximum of one card as a hit. The hand identification system of some embodiments of the invention may be able to address the needs of identifying hands in each of these types of games and especially may be able to identify hands in the a complex situation, the play of blackjack.

In various embodiments, where cameras are used to read cards, the light sensitive system may be any image capture system, digital or analog, that is capable of identifying the suit and rank of a card.

In various embodiments, a first step in the operation is to provide a set of cards to the smart delivery shoe, the cards being those cards that are going to be used in the play of a casino table card game. The set of cards (usually one or more decks) is provided in an already randomized set, being taken out of a shuffler or having been shuffled by hand. A smart delivery shoe is described in U.S. patent application Ser. No. 10/622,321, titled SMART DELIVERY SHOE, which application is incorporated herein in its entirety by reference. Some delivery systems or shoes with reading capability include, but are not limited to those disclosed in U.S. Pat. Nos. 4,750,743; 5,779,546; 5,605,334; 6,361,044; 6,217,447; 5,941,769; 6,229,536; 6,460,848; 5,722,893; 6,039,650; and 6,126,166. In various embodiments, the cards are read in the smart card delivery shoe, such as one card at a time in sequence. Reading cards by edge markings and special codes (as in U.S. Pat. No. 6,460,848) may require special encoding and marking of the cards. The entire sequence of cards in the set of cards may thus be determined and stored in memory. Memory may be at least in part in the smart delivery shoe, but communication with a central processor is possible. The sequence would then also or solely be stored in the central computer.

In various embodiments, the cards are then dealt out of the smart delivery shoe, the delivery shoe registering how many cards are removed one-at-a-time. This may be accomplished by the above identified U.S. patent application Ser. No. 10/622,321 where cards are fed to the dealer removal area one at a time, so only one card can be removed by the dealer. As each card is removed, a signal is created indicating that a specific card (of rank and suit) has been dealt. The computer and system knows only that a first card has been dealt, and it is presumed to go to the first player. The remaining cards are dealt out to players and dealer. In the play of certain games (e.g., stud variants) where specific numbers of cards are known to be dealt to each position, the shoe may be programmed with the number of players at any time, so hands can be correlated even before they have been dealt. If the shoe is playing a stud variant where each player and the dealer gets three cards (Three Card Poker™ game), the system may know in advance of the deal what each player and the dealer will have as a hand. It is also possible that there be a signal available when the dealer has received either his first card (e.g., when cards are dealt in sequence, one-at-a-time) or has received his entire hand. The signal may be used to automatically determine the number of player positions active on the table at any given time. For example, if in a hand of blackjack the dealer receives the sixth card, the system may immediately know that there are five players at the table. The signal can be given manually (pressing a button at the dealer position or on the smart card delivery shoe) or can be provided automatically (a card presence sensor at the dealer's position, where a card can be placed over the sensor to provide a signal). Where an automatic signal is provided by a sensor, some physical protection of the sensor may be provided, such as a shield that would prevent accidental contact with the sensor or blockage of the sensor. An L-shaped cover may be used so a card could be slid under the arm of the L parallel to the table surface and cover the sensor under that branch of the L. The signal can also be given after all cards for the hand have been delivered, again indicating the number of players, For example, when the dealer's two cards are slid under the L-shaped cover to block or contact the sensor, the system may know the total number of cards dealt on the hand (e.g., 10 cards), know that the dealer has 2 cards, determine that players therefore have 8 cards, and know that each player has 2 cards each, thereby absolutely determining that there are four active player positions at the table (10−2=8 and then 8/2=4 players). This automatic determination may serve as an alternative to having dealers input the number of players each hand at a table or having to manually change the indicated number of players at a table each time the number changes.

Once all active positions have been dealt to, the system may now know what cards are initially present in each player's hand, the dealer's hand, and any flop or common hand. The system operation may now be simple when no more cards are provided to play the casino table game. All hands may then be known and all outcomes may be predicted. The complication of additional cards will be addressed with respect to the game of blackjack.

After dealing the initial set of two cards per hand, the system may not immediately know where each remaining card will be dealt. The system may know what cards are dealt, however. It is with this knowledge and a subsequent identification of discarded hands that the hands and cards from the smart delivery shoe can be reconciled or verified. Each hand is already identified by the presence of two specifically known cards. Hands are then played according to the rules of the game, and hands are discarded when play of a hand is exhausted. A hand is exhausted when 1) there is a blackjack, the hand is paid, and the cards are cleared; 2) a hand breaks with a count over twenty-one and the cards are cleared; and/or a round of the game is played to a conclusion, the dealer's hand completed, all wagers are settled, and the cards are cleared. As is typically done in a casino to enable reconciling of hands manually, cards are picked up in a precise order from the table. The cards are usually cleared from the dealer's right to the dealer's left, and the cards at each position comprise the cards in the order that they were delivered, first card on the bottom, second card over the first card, third card over the second card, etc. maintaining the order or a close approximation of the order (e.g., the first two cards may be reversed) is important as the first two cards form an anchor, focus, basis, fence, end point or set edge for each hand. For example, if the third player position was known to have received the 10 of hearts (10H) and the 9 of spades (9S) for the first two card, and the fourth player was known to receive the 8 of diamonds (8D) and the 3 of clubs (3C) for the first two cards, the edges or anchors of the two hands are 9S/10H and 8D/3C. When the hands are swept at the conclusion of the game, the cards are sent to a smart discard rack (e.g., see U.S. patent application Ser. No. 10/622,388, which application is incorporated herein by reference in its entirety) and the hand with the 9S/10H was not already exhausted (e.g., broken or busted) and the swept cards consist of 9S, 10H, 8S, 8D and 3C (as read by the smart discard rack), the software of the processor may automatically know that the final hands in the third and fourth positions were a count of 19 (9S and 10H) for the third hand and 19 (8D and 3C originally plus the 8S hit) for the fourth hand. The analysis by the software specifically identifies the fourth hand as a count of 19 with the specific cards read by the smart discard shoe. The information from reading that now exhausted hand is compared with the original information collected from the smart delivery shoe. The smart delivery shoe information when combined with the smart discard rack information shall confirm the hands in each position, even though cards were not uniformly distributed (e.g., player one takes two hits for a total of four cards, player two takes three hits for a total of five cards, player three takes no hit for a total of two cards, player four takes one hit for a total of three cards, and the dealer takes two hits for a total of four cards).

The dealer's cards may be equally susceptible to analysis in a number of different formats. After the last card has been dealt to the last player, a signal may be easily and imperceptibly generated that the dealer's hand will now become active with possible hits. For example, with the sensor described above for sensing the presence of the first dealer card or the completion of the dealer's hand, the cards would be removed from beneath the L-shaped protective bridge. This type of movement is ordinarily done in blackjack where the dealer has at most a single card exposed and one card buried face down. In this case, the removal of the cards from over the sensor underneath the L-cover to display the hole card is a natural movement and then exposes the sensor. This can provide a signal to the central processor that the dealer's hand will be receiving all additional cards in that round of the game. The system at this point knows the two initial cards in the dealer's hand, knows the values of the next sequence of cards, and knows the rules by which a dealer may play. The system knows what cards the dealer will receive and what the final total of the dealer's hand will be because the dealer has no freedom of decision or movement in the play of the dealer's hand. When the dealer's hand is placed into the smart discard rack, the discard rack already knows the specifics of the dealer's hand even without having to use the first two cards as an anchor or basis for the dealer's hand. The cards may be treated in this manner in some embodiments.

When the hands are swept from the table, dealer's hand then players' hands from right to left (from the dealer's position or vice-versa if that is the manner of house play), the smart discard rack reads the shoes, identifies the anchors for each hand, knows that no hands swept at the conclusion can exceed a count of twenty-one, and the computer identifies the individual hands and reconciles them with the original data from the smart delivery shoe. The system thereby can identify each hand played and provide system assurance that the hand was played fairly and accurately.

If a lack of reconciling by the system occurs, a number of events can occur. A signal can be given directly to the dealer position, to the pit area, or to a security zone and the cards examined to determine the nature and cause of the error and inspect individual cards if necessary. When the hand and card data is being used for various statistical purposes, such as evaluating dealer efficiency, dealer win/loss events, player efficiency, player win/loss events, statistical habits of players, unusual play tactics or meaningful play tactics (e.g., indicative of card counting), and the like, the system may file the particular hand in a ‘dump’ file so that hand is not used in the statistical analysis, this is to assure that maximum benefits of the analysis are not tilted by erroneous or anomalous data.

Various embodiments may include date stamping of each card dealt (actual time and date defining sequence, with concept of specific identification of sequence identifier possibly being unique). The date stamping may also be replaced by specific sequence stamping or marking, such as a specific hand number, at a specific table, at a specific casino, with a specific number of players, etc. The records could indicate variations of indicators in the stored memory of the central computer of Lucky 777 Casino, Aug. 19, 1995, 8:12:17 a.m., Table 3, position 3, hand 7S/4D/9S, or simply identify something similar by alphanumeric code as L7C-819-95-3-3-073-7S/4D/9S (073 being the 73^{rd} hand dealt). This date stamping of hands or even cards in memory can be used as an analytical search tool for security and to enhance hand identification.

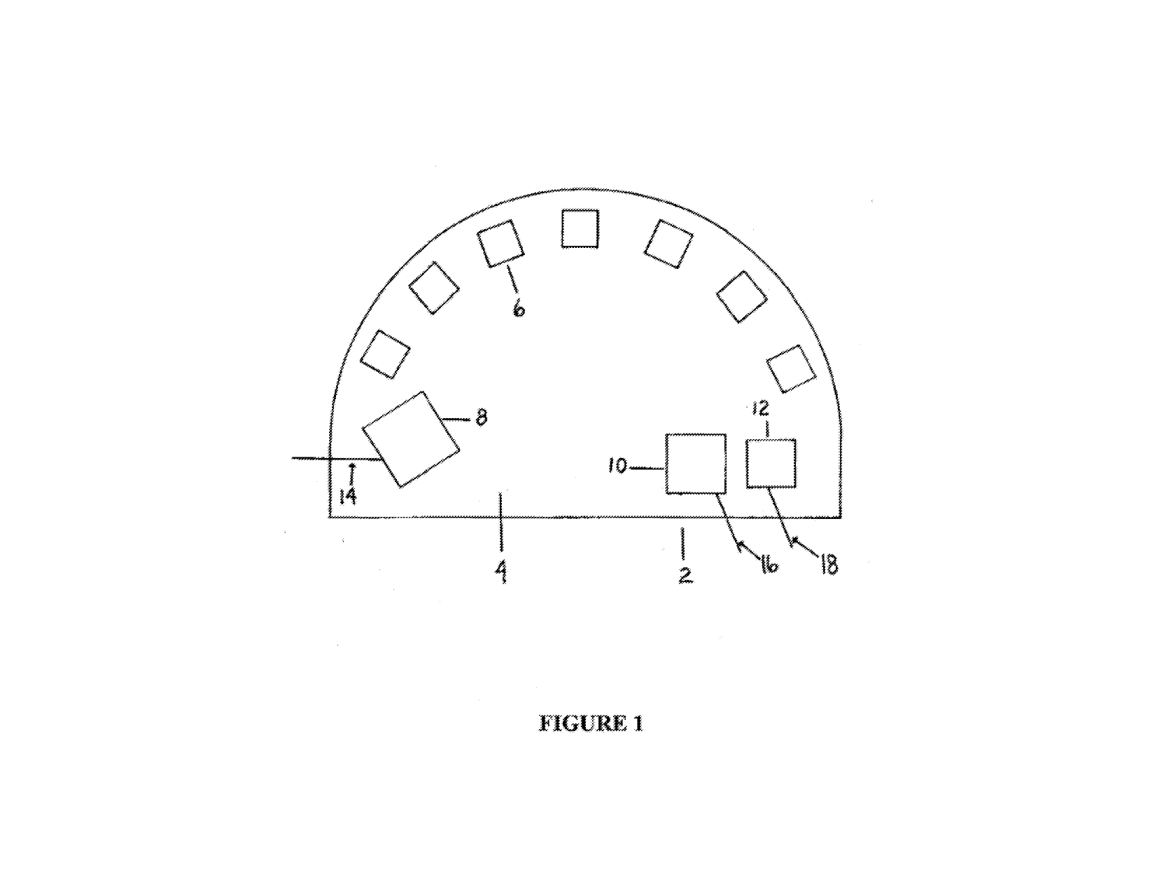

FIG. 1 shows a block diagram of the minimum components for the hand-reading system on a table 4 of some embodiments, a smart card-reading delivery shoe 8 with output 14 and a smart card-reading discard rack 12 with output 18. Player positions 6 are shown, as is a dealer's hand position sensor 10 without output port 16.

The use of the discard rack acting to reconcile hands returned to the discard rack out-of-order (e.g., blackjack or bust) automatically may be advantageous, in some embodiments. The software as described above can be programmed to recognize hands removed out-of-dealing order on the basis of knowledge of the anchor cards (the first two cards) known to have been dealt to a specific hand. For example, the software will identify that when a blackjack was dealt to position three, that hand will be removed, the feed of the third hand into the smart card discard tray confirms this, and position three will essentially be ignored in future hand resolution. More importantly, when the anchor cards were, for example, 9S/5C in the second player position and an exhausted hand of 8D/9S/5C is placed into the smart discard rack, that hand will be identified as the hand from the second player position. If two identical hands happen to be dealt in the same round of play, the software will merely be alerted (it knows all of the hands) to specifically check the final order of cards placed into the smart discard rack to more carefully position the location of that exhausted hand. This is merely recognition software implementation once the concept is understood.

That the step of removal of cards from the dealer's sensor or other initiated signal identifies that all further cards are going to the dealer may be useful in defining the edges of play between rounds and in identifying the dealer's hand and the end of a round of play. When the dealer's cards are deposited and read in the smart discard rack, the central computer knows that another round of play is to occur and a mark or note may be established that the following sequence will be a new round and the analytical cycle may begin all over again.

The discard rack indicates that a complete hand has been delivered by absence of additional cards in the Discard Rack in-feed tray. When cards are swept from an early exhausted hand (blackjack or a break), they are swept one at a time and inserted into the smart discard rack one at a time. When the smart discard rack in-feed tray is empty, the system understands that a complete hand has been identified, and the system can reconcile that specific hand with the information from the smart delivery shoe. The system can be hooked-up to feed strategy analysis software programs such as the SMI licensed proprietary Bloodhound™ analysis program.

Various embodiments include a casino or cardroom game modified to include a progressive jackpot component. During the play of a Twenty-One game, for example, in addition to this normal wager, a player will have the option of making an additional wager that becomes part of, and makes the player eligible to win, the progressive jackpot. If the player's Twenty-One hand comprises a particular, predetermined arrangement of cards, the player will win all, or part of, the amount showing on the progressive jackpot. This progressive jackpot feature is also adaptable to any other casino or cardroom game such as Draw Poker, Stud Poker, Lo-Ball Poker or Caribbean Stud™ Poker. Various embodiments include a gaming table, such as those used for Twenty-One or poker, modified with the addition of a coin acceptor that is electronically connected to a progressive jackpot meter. When player drops a coin into the coin acceptor, a light is activated at the player's location indicating that he is participating in the progressive jackpot component of the game during that hand. At the same time, a signal from the coin acceptor is sent to the progressive meter to increment the amount shown on the progressive meter. At the conclusion of the play of each hand, the coin acceptor is reset for the next hand. When a player wins all or part of the progressive jackpot, the amount showing on the progressive jackpot meter is reduced by the amount won by the player. Any number of gaming tables can be connected to a single progressive jackpot meter.

### XV. CARD SHUFFLERS

Various embodiments include an automatic card shuffler, including a card mixer for receiving cards to be shuffled in first and second trays. Sensors detect the presence of cards in these trays to automatically initiate a shuffling operation, in which the cards are conveyed from the trays to a card mixer, which randomly interleaves the cards delivered to the mixing mechanism and deposits the interleaved cards in a vertically aligned card compartment.

A carriage supporting an ejector is reciprocated back and forth in a vertical direction by a reversible linear drive while the cards are being mixed, to constantly move the card ejector along the card receiving compartment. The reversible linear drive is preferably activated upon activation of the mixing means and operates simultaneously with, but independently of, the mixing means. When the shuffling operation is terminated, the linear drive is deactivated thereby randomly positioning the card ejector at a vertical location along the card receiving compartment.

A sensor arranged within the card receiving compartment determines if the stack of cards has reached at least a predetermined vertical height. After the card ejector has stopped and, if the sensor in the compartment determines that the stack of cards has reached at least the aforesaid predetermined height, a mechanism including a motor drive, is activated to move the wedge-shaped card ejector into the card receiving compartment for ejecting a group of the cards in the stack, the group selected being determined by the vertical position attained by the wedge-shaped card ejector.

In various embodiments, the card ejector pushes the group of cards engaged by the ejector outwardly through the forward open end of the compartment, said group of cards being displaced from the remaining cards of the stack, but not being completely or fully ejected from the stack.

The card ejector, upon reaching the end of its ejection stroke, detected by a microswitch, is withdrawn from the card compartment and returned to its initial position in readiness for a subsequent shuffling and card selecting operation.

In various embodiments, a technique for randomly selecting the group of cards to be ejected from the card compartment utilizes solid state electronic circuit means, which may comprise either a group of discrete solid state circuits or a microprocessor, either of which techniques preferably employ a high frequency generator for stepping a N-stage counter during the shuffling operation. When the shuffling operation is completed, the stepping of the counter is terminated. The output of the counter is converted to a DC signal, which is compared against another DC signal representative of the vertical location of the card ejector along the card compartment.

In various embodiments, a random selection is made by incrementing the N-stage counter with a high frequency generator. The high frequency generator is disconnected from the N-stage counter upon termination of the shuffling operation. The N-stage counter is then incremented by a very low frequency generator until it reaches its capacity count and resets. The reciprocating movement of the card ejector is terminated after completion of a time interval of random length and extending from the time the high frequency generator is disconnected from the N-stage counter to the time that the counter is advanced to its capacity count and reset by the low frequency generator, triggering the energization of the reciprocating drive, at which time the card ejector carriage coasts to a stop.

In various embodiments, the card ejector partially ejects a group of cards from the stack in the compartment. The partially displaced group of cards is then manually removed from the compartment. In another preferred embodiment, the ejector fully ejects the group of cards from the compartment, the ejected cards being dropped into a chute, which delivers the cards directly to a dealing shoe. The pressure plate of the dealing shoe is initially withdrawn to a position enabling the cards passing through the delivery shoe to enter directly into the dealing shoe, and is thereafter returned to its original position at which it urges the cards towards the output end of the dealing shoe.

Various embodiments include a method and apparatus for automatically shuffling and cutting playing cards and delivering shuffled and cut playing cards to the dispensing shoe without any human intervention whatsoever once the playing cards are delivered to the shuffling apparatus. In addition, the shuffling operation may be performed as soon as the play of each game is completed, if desired, and simultaneously with the start of a new game, thus totally eliminating the need to shuffle all of the playing cards (which may include six or eight decks, for example) at one time. Preferably, the cards played are collected in a “dead box” and are drawn from the dead box when an adequate number of cards have been accumulated for shuffling and cutting using the method of the present invention.

Various embodiments include a computer controlled shuffling and cutting system provided with a housing having at least one transparent wall making the shuffling and card delivery mechanism easily visible to all players and floor management in casino applications. The housing is provided with a reciprocally slidable playing card pusher which, in the first position, is located outside of said housing. A motor-operated transparent door selectively seals and uncovers an opening in the transparent wall to permit the slidably mounted card pusher to be moved from its aforementioned first position to a second position inside the housing whereupon the slidably mounted card pusher is then withdrawn to the first position, whereupon the playing cards have been deposited upon a motorized platform which moves vertically and selectively in the upward and downward directions.

The motor driven transparent door is lifted to the uncovered position responsive to the proper location of the motor driven platform, detected by suitable sensor means, as well as depression of a foot or hand-operated button accessible to the dealer.

The motor driven platform (or “elevator”) lifts the stack of playing cards deposited therein upwardly toward a shuffling mechanism responsive to removal of the slidably mounted card pusher and closure of the transparent door whereupon the playing cards are driven by the shuffling mechanism in opposing directions and away from the stack to first and second card holding magazines positioned on opposing sides of the elevator, said shuffling mechanism comprising motor driven rollers rotatable upon a reciprocating mounting device, the reciprocating speed and roller rotating speed being adjustable. Alternatively, however, the reciprocating and rotating speeds may be fixed; if desired, employing motors having fixed output speeds, in place of the stepper motors employed in one preferred embodiment.

Upon completion of a shuffling operation, the platform is lowered and the stacks of cards in each of the aforementioned receiving compartments are sequentially pushed back onto the moving elevator by suitable motor-driven pushing mechanisms. The order of operation of the pushing mechanisms is made random by use of a random numbers generator employed in the operating computer for controlling the system. These operations can be repeated, if desired. Typically, new cards undergo these operations from two to four times.

Guide assemblies guide the movement of cards onto the platform, prevent shuffled cards from being prematurely returned to the elevator platform and align the cards as they fall into the card receiving regions as well as when they are pushed back onto the elevator platform by the motor-driven pushing mechanism.

Upon completion of the plurality of shuffling and cutting operations, the platform is again lowered, causing the shuffled and cut cards to be moved downwardly toward a movable guide plate having an inclined guide surface.

As the motor driven elevator moves downwardly between the guide plates, the stack of cards engages the inclined guide surface of a substantially U-shaped secondary block member causing the stack to be shifted from a horizontal orientation to a diagonal orientation. Substantially simultaneously therewith, a “drawbridge-like” assembly comprised of a pair of swingable arms pivotally mounted at their lower ends, are swung downwardly about their pivot pin from a vertical orientation to a diagonal orientation and serve as a diagonally aligned guide path. The diagonally aligned stack of cards slides downwardly along the inclined guide surfaces and onto the draw bridge-like arms and are moved downwardly therealong by the U-shaped secondary block member, under control of a stepper motor, to move cards toward and ultimately into the dealing shoe.

A primary block, with a paddle, then moves between the cut-away portion of the U-shaped secondary block, thus applying forward pressure to the stack of cards. The secondary block then retracts to the home position. The paddle is substantially rectangular-shaped and is aligned in a diagonal orientation. Upon initial set-up of the system the paddle is positioned above the path of movement of cards into the dealing shoe. The secondary block moves the cut and shuffled cards into the dealing shoe and the paddle is lowered to the path of movement of cards toward the dealing shoe and is moved against the rearward most card in the stack of cards delivered to the dealing shoe. When shuffling and cutting operations are performed subsequent to the initial set-up, the paddle rests against the rearward most card previously delivered to the dealing shoe. The shuffled and cut cards sliding along the guide surfaces of the diagonally aligned arms of the draw bridge-like mechanism come to rest upon the opposite surface of the paddle which serves to isolate the playing cards previously delivered to the dispensing shoe, as well as providing a slight pushing force urging the cards toward the outlet slot of the dispensing shoe thereby enabling the shuffling and delivering operations to be performed simultaneously with the dispensing of playing cards from the dispensing shoe.

After all of the newly shuffled playing cards have been delivered to the rear end of the dispensing shoe, by means of the U-shaped secondary block the paddle which is sandwiched between two groups of playing cards, is lifted to a position above and displaced from the playing cards. A movable paddle mounting assembly is then moved rearwardly by a motor to place the paddle to the rear of the rearmost playing card just delivered to the dispensing shoe; and the paddle is lowered to its home position, whereupon the motor controlling movement of the paddle assembly is then deenergized enabling the rollingly-mounted assembly supporting the paddle to move diagonally downwardly as playing cards are dispensed from the dispensing shoe to provide a force which is sufficient to urge the playing cards forwardly toward the playing card dispensing slot of the dealing shoe. The force acting upon the paddle assembly is the combination of gravity and a force exerted upon the paddle assembly by a constant tension spring assembly. Jogging (i.e., “dither”) means cause the paddle to be jogged or reciprocated in opposing forward and rearward directions at periodic intervals to assure appropriate alignment, stacking and sliding movement of the stack of playing cards toward the card dispensing slot of the dealing shoe.

Upon completion of a game, the cards used in the completed game are typically collected by the dealer and placed in a dead box on the table. The collected cards are later placed within the reciprocally movable card pusher. The dealer has the option of inserting the cards within the reciprocally slidable card pusher into the shuffling mechanism or, alternatively, and preferably, may postpone a shuffling operation until a greater number of cards have been collected upon the reciprocally slidable card pusher. The shuffling and delivery operations may be performed as often or as infrequently as the dealer or casino management may choose. The shuffling and playing card delivery operations are fully automatic and are performed without human intervention as soon as cards are inserted within the machine on the elevator platform. The cards are always within the unobstructed view of the players to enable the players, as well as the dealer, to observe and thereby be assured that the shuffling, cutting and card delivery operations are being performed properly and without jamming and that the equipment is working properly as well. The shuffling and card delivery operations do not conflict or interfere with the dispensing of cards from the dispensing shoe, thereby permitting these operations to be performed substantially simultaneously, thus significantly reducing the amount of time devoted to shuffling and thereby greatly increasing the playing time, as well as providing a highly efficient random shuffling and cutting mechanism.

The system may be controlled by a microcomputer programmed to control the operations of the card shuffling and cutting system. The computer controls stepper motors through motor drive circuits, intelligent controllers and an opto-isolator linking the intelligent controllers to the computer. The computer also monitors a plurality of sensors to assure proper operation of each of the mechanisms of the system.

### XVI. CASINO COUNTERMEASURES

Some methods of thwarting card counters include using a large number of decks. Shoes containing 6 or 8 decks are common. The more cards there are, the less variation there is in the proportions of the remaining cards and the harder it is to count them. The player's advantage can also be reduced by shuffling the cards more frequently, but this reduces the amount of time that can be devoting to actual play and therefore reduces the casino profits. Some casinos now use shuffling machines, some of which shuffle one set of cards while another is in play, while others continuously shuffle the cards. The distractions of the gaming floor environment and complimentary alcoholic beverages also act to thwart card counters. Some methods of thwarting card counters include using varied payoff structures, such Blackjack payoff of 6:5, which is more disadvantageous to the player than the standard 3:2 Blackjack payoff.

### XVII. VIDEO WAGERING GAMES

Video wagering games are set up to mimic a table game using adaptations of table games rules and cards.

In one version of video poker the player is allowed to inspect five cards randomly chosen by the computer. These cards are displayed on the video screen and the player chooses which cards, if any, that he or she wishes to hold. If the player wishes to hold all of the cards, i.e., stand, he or she presses a STAND button. If the player wishes to hold only some of the cards, he or she chooses the cards to be held by pressing HOLD keys located directly under each card displayed on the video screen. Pushing a DEAL button after choosing the HOLD cards automatically and simultaneously replaces the unchosen cards with additional cards which are randomly selected from the remainder of the deck. After the STAND button is pushed, or the cards are replaced, the final holding is evaluated by the game machine's computer and the player is awarded either play credits or a coin payout as determined from a payoff table. This payoff table is stored in the machine's computer memory and is also displayed on the machine's screen. Hands with higher poker values are awarded more credits or coins. Very rare poker hands are awarded payoffs of 800-to-1 or higher.

### XVIII. APPARATUS FOR PLAYING OVER A COMMUNICATIONS SYSTEM

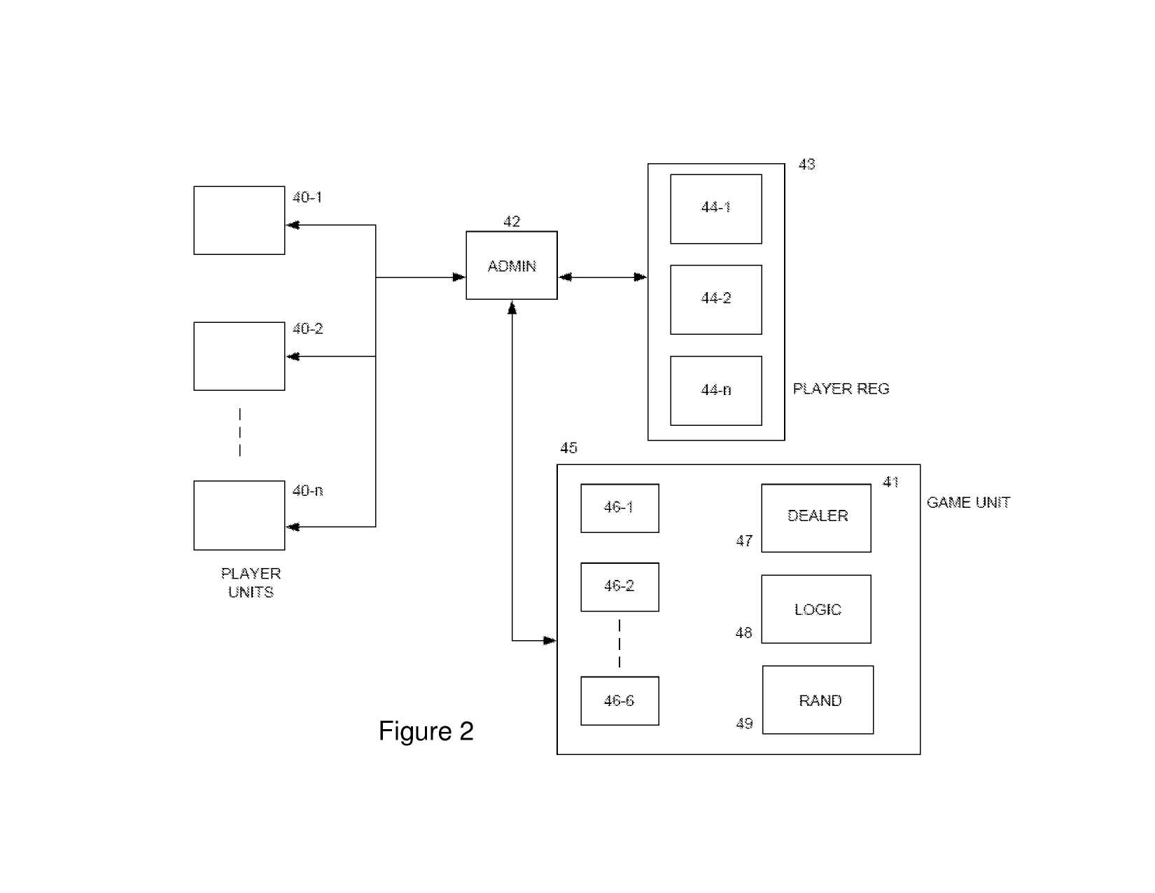

FIG. 2 shows apparatus for playing the game. There is a plurality of player units 40-1 to 40-n which are coupled via a communication system 41, such as the Internet, with a game playing system comprising an administration unit 42, a player register 43, and a game unit 45. Each unit 40 is typically a personal computer with a display unit and control means (a keyboard and a mouse).

When a player logs on to the game playing system, their unit 40 identifies itself to the administration unit. The system holds the details of the players in the register 43, which contains separate player register units 44-1 to 44-n for all the potential players, i.e., for all the members of the system.

Once the player has been identified, the player is assigned to a game unit 45. The game unit contains a set of player data units 46-1 to 46-6, a dealer unit 47, a control unit 48, and a random dealing unit 49.

Up to seven players can be assigned to the game unit 45. There can be several such units, as indicated, so that several games can be played at the same time if there are more than seven members of the system logged on at the same time. The assignment of a player unit 40 to a player data unit 46 may be arbitrary or random, depending on which player data units 46 and game units 45 are free. Each player data unit 46 is loaded from the corresponding player register unit 44 and also contains essentially the same details as the corresponding player unit 40, and is in communication with the player unit 40 to keep the contents of the player unit and player data unit updated with each other. In addition, the appropriate parts of the contents of the other player data units 46 and the dealer unit 47 are passed to the player unit 40 for display.

The logic unit 48 of the game unit 45 steps the game unit through the various stages of the play, initiating the dealer actions and awaiting the appropriate responses from the player units 40. The random dealing unit 49 deals cards essentially randomly to the dealer unit 47 and the player data units 46. At the end of the hand, the logic unit passes the results of the hand, i.e., the wins and/or losses, to the player data units 46 to inform the players of their results. The administrative unit 42 also takes those results and updates the player register units 44 accordingly.

The player units 40 are arranged to show a display. To identify the player, the player's position is highlighted. As play proceeds, so the player selects the various boxes, enters bets in them, and so on, and the results of those actions are displayed. As the cards are dealt, a series of overlapping card symbols is shown in the Bonus box. At the option of the player, the cards can be shown in a line below the box, and similarly for the card dealt to the dealer. At the end of the hand, a message is displayed informing the player of the results of their bets, i.e., the amounts won or lost.

### XIX. ALTERNATIVE TECHNOLOGIES

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

### XX. REFERENCES

The following patents and patent applications are hereby incorporated by reference herein for all purposes: U.S. Pat. No. 6,579,181, U.S. Pat. No. 6,299,536, U.S. Pat. No. 6,093,103, U.S. Pat. No. 5,941,769, U.S. Pat. No. 7,114,718, U.S. patent application Ser. No. 10/622,321, U.S. Pat. No. 4,515,367, U.S. Pat. No. 5,000,453, U.S. Pat. No. 7,137,630, U.S. Pat. No. 7,137,629, U.S. patent application Ser. No. 11/063,311.

### XXI. EXAMPLE EVENT WAGERS

Some embodiments may include wagers at a sports book or other venue for placing wagers on one or more competitions and/or events. Some example competitions and/or on which a wager may be placed at a sports book may include auto racing, baseball, basketball, boxing, football, golf, hockey, poker tournaments, political races, weather, and horse racing. Each competition and/or event type may have a different set of odds associated therewith.

In auto racing for example a sports book may list some number of individual drivers and/or a field (all other) option. Each individual driver and/or the field may be associated with some odds for each type of bet. For example, Jeff Gordon may be listed at 4-1, Jeff Burton at 15-1, Casey Atwood at 100-1, etc. If you bet $10 on Burton 15-1 and he goes on to win the race, you win $150 plus your $10 back, for a total payoff of $160. Matchup wagers may be available in which two or more drivers are paired against each other in a head-to-head wager. Odds for such a wager may also be provided. For example, a matchup may pit Dale Jarrett (minus 145) against Bobby Labonte (plus 125). If you bet $145 on the favored Jarrett, the payoff would be $100 plus your $145 back, for a total of $245. If you bet $100 on the underdog Labonte, the payoff would be $125 plus your $100 back, for a total of $225. Various other wagers may also be available such as, for example, an over/under on a number of cautions in a race, a car manufacturer that will win the race, in-game wagers, and so on.

In baseball for example, a sports book may list each team matchup with an odds associated with each team of each matchup. If a team on which a wager is placed wins a matchup, the payout to the winner may vary according to the odds. In some embodiments, baseball odds are shown using a money line.

In a money line, odds may be based on some dollar value (e.g., $1). In a money line, A “minus” preceding a number indicates the team is a favorite. A “plus” preceding a number indicates the team is an underdog. For example, if the Braves' odds are −120, this may mean that a $12 bet would win $10, for a return of $22. As another example, if the Dodgers' odds are +110, this may mean that a $10 bet would win $11, for a return of $21. Various types of money lines exist, such as dime lines and 20-cent lines and may be used in various embodiments. Some embodiments may not list a price for an underdog in a matchup but may instead use a house line for underdogs. Some embodiments may include various other wagers, such as, for example, an over under on a total runs scored, a run line, a parlay in which a bettor may select multiple teams to win, in-game wagers, and so on.

Money lines may change as wagering proceeds. In some embodiments, an odds determined by the money line at the time of a wager may be the odds used to payout a wager at the end of a wager. In some embodiments, the money line at the end of a wagering period may be used to determine the odds of wager even if the money line was different when the wager was placed.

In basketball, for example, a sports book may operate similar to baseball. In some embodiments, a point spread may be used so that a bet on a team to win will win only if the team wins by the point spread. In some embodiments, the odds may be the same for all wagers, but the point spread may be changed. For example, a point spread may increase as more bettors wager on a team to win, similar to a change in the odds discussed above with respect to baseball. Some embodiments may allow “teasing” of a point spread (i.e., changing the point spread) in exchange for a change to the odds. Various other wagers may be includes in some embodiments, such as parlays, over under on point totals, in game wagers, and so on.

In boxing, for example, a sports book may operate a money line similar to a baseball money line described above. In hockey and football, for example, a sports book may operate a money line similar to a basketball money line described above.

In golf, for example, a sports book may operate a wagering method and/or system similar to auto racing described above. For example, a sports book may list a number of individual golfers and a field. Each option may be associated with an odds for each type of bet (e.g., to win a tournament). For example, Tiger Woods may be listed at 2-1, Tom Lehman at 25-1, Bob May at 100-1, etc. If you bet $10 on Lehman at 25-1 and he goes on to win the tournament, you win $250 plus your $10 back, for a total payoff of $260. A sports book may also include matchup propositions between two or more golfers. In some embodiments, one golfer may be matched against two or more golfers in such a proposition. Various other wagers may be included in some embodiments, such as over under on the winning score, over under on the lowest round by any golfer, over under on a finishing position of a golfer, in-game wagers, and so on.

In horse racing, for example, a sports book may provide a wide array of betting options. For example, a win, place, show, across the board, exacta, quinella, trifecta, superfecta, daily double, pick six, and so on wagering options may be available as well as any in-game wagers. Each wager option may be associated with a money line such as those described above or other type of odds system.

Some embodiments may include various events or propositions that may be wagered upon, such as outcomes of an election, winnings of an award, and so on. Some embodiments may include wagers on an outcome of a season of a game, a season of a television show (e.g., Survivor), and so on. Some embodiments may include wagers on other casino games (e.g., craps, blackjack, slots, poker). Such bets may include bets on individual games, bets on other people, bets on statistics of the games, bets on tournaments of such games, and so on. It should be recognized that the examples of various wager types and odds types are given as non-limiting examples only and that various embodiments may include any desired wager types and/or odds types.

It should be recognized that an embodiment may include one or more components of any embodiment described herein or elsewhere in any combination and/or arrangement. Some embodiments may include no such elements at all but may include alternative, different, additional, fewer, and so on elements. It should be recognized that some other embodiments may include various features in any combination. Other embodiments may include different, additional, alternative, fewer, more, and so on features in any combination.

### XXIII. EMBODIMENTS

The following should be understood to be embodiments and not claims.

A. An apparatus comprising: a non-transitory machine readable medium having stored thereon a plurality of instructions that when executed by a computing device cause the computing device to: determine an amount of money wagered on each side of a two sided wager proposition through a first wagering venue; determine a level of risk exposure for a first side of the two sided wager proposition based on money wagered on the first side; determine a level of offsetting risk for the first side of the two sided wager proposition based on money wagered on a second side of the two sided wager proposition; determine a total level of risk exposure based on the risk exposure and the offsetting risk exposure; determine that the total risk exposure is greater than a threshold value; and in response to determining that the total risk exposure is greater than the threshold value, facilitate a hedging transaction to offload at least a part of the total level of risk.

A.1. The apparatus of claim A, in which the computing device is caused to: determine a second amount of money wagered on each side of the two sided wager proposition through a second wagering venue; in which determining the level of risk exposure includes determining the level of risk exposure based on money wagered through both the first and second wagering venues; and in which determining the level of offsetting risk exposure includes determining the level of offsetting risk exposure based on money wagered through both the first and second wagering venues. A.1.1. The apparatus of claim A.1, in which facilitating the hedging transaction includes directing a third wagering facility that is distinct from the first and second wagering facilities to engage in a wagering action such that a sum of risks across the first, second, and third wagering facilities would be below the threshold level after the wagering action.

A.2. The apparatus of claim A, in which the hedging transaction includes selling responsibility for one or more wagers to a second wagering venue. A.3. The apparatus of claim A, in which the hedging transaction includes placing an order through an exchange on which wagers may be purchased and sold. A.4. The apparatus of claim A, in which the hedging transaction includes entering into a wager with a second wagering venue. A.5. The apparatus of claim A, in which facilitating the hedging transaction includes directing a second wagering facility that is distinct from the first wagering facility to engage in a wagering action. A.6. The apparatus of claim A, in which facilitating a hedging transaction includes determining whether a transaction that would reduce the total risk exposure is legal in a jurisdiction of the first wagering venue, and if the transaction is legal, engaging in the transaction locally, and if the transaction is not legal, communicating the total risk exposure to a central authority in a different jurisdiction so that the central authority may engage in the transaction. A.6.1. The apparatus of claim A.6, in which the apparatus further comprises the central authority and in which the central authority is configured to receive a plurality of risk levels for the wager propositions from various wagering venues, sum the various risk levels, and facilitate hedging of the summed risk.

A.7. The apparatus of claim A, in which facilitating the hedging transaction includes attempting to have both a second and third wagering venues engage the hedging transaction. A.7.1. The apparatus of claim A.7, in which the computing device is caused to determine that the second wagering venue engaging in a part of the hedging transaction and adjusting the attempts by the third wagering venue to only include an attempt to engage in a remaining part of the hedging transaction. A.8. The apparatus of claim A, in which determining the amount of money wagered on each side includes receiving a report from the first wagering venue indicating the amount of money. A.8.1. The apparatus of claim A.8, in which the report is transmitted in a manner that is allowed by a jurisdiction of the first wagering venue and in which a second amount of money wagered through a second wagering venue is received from a second wagering venue in a different jurisdiction in a different manner that is allowed in the second jurisdiction but not the first jurisdiction. A.9. The apparatus of claim A, in which the level of risk exposure includes an amount of money that the first wagering venue would be responsible for paying out if the first side of the wager proposition is a winning side. A.10. The apparatus of claim A, in which the two sided wager proposition includes a fixed odds wager on the outcome of a sporting event. A.11. The apparatus of claim A, in which the computing device is caused to instruct the first wagering venue and a second wagering venue to offer the two sided wager proposition at a different odds in response to determine that the total risk is greater than the threshold value.

B. A method comprising: determining an amount of money wagered on each side of a two sided wager proposition through a first wagering venue; determining, by a computing device, a level of risk exposure for a first side of the two sided wager proposition based on money wagered on the first side; determining, by the computing device, a level of offsetting risk for the first side of the two sided wager proposition based on money wagered on a second side of the two sided wager proposition; determining, by the computing device, a total level of risk exposure based on the risk exposure and the offsetting risk exposure; determining, by the computing device, that the total risk exposure is greater than a threshold value; and in response to determining that the total risk exposure is greater than the threshold value, facilitating, by the computing device, a hedging transaction to offload at least a part of the total level of risk.

C. An apparatus comprising: a non-transitory machine readable medium having stored thereon a plurality of instructions that when executed by a computing device cause the computing device to: receive a first level of risk exposure for a first side of a two sided wager proposition based on money wagered on the first side at a first wagering venue; receive a second level of risk exposure for the first side of the two sided wager proposition based on money wagered on the first side at a second wagering venue; receive a third level of risk exposure for a second side of the two sided wager proposition based on money wagered on the second side at a third wagering venue; determine a total level of risk exposure of a gaming operator by summing the first level and the second level and subtracting the third level; in response to determining the total level of risk exposure, direct a fourth wagering venue to engage in an offsetting wager transaction that would reduce the total level of risk exposure.

D. A method comprising: receiving, by a computing device, a first level of risk exposure for a first side of a two sided wager proposition based on money wagered on the first side at a first wagering venue; receiving, by the computing device, a second level of risk exposure for the first side of the two sided wager proposition based on money wagered on the first side at a second wagering venue; receiving, by the computing device, a third level of risk exposure for a second side of the two sided wager proposition based on money wagered on the second side at a third wagering venue; determining, by the computing device, a total level of risk exposure of a gaming operator by summing the first level and the second level and subtracting the third level; in response to determining the total level of risk exposure, directing, by the computing device, a fourth wagering venue to engage in an offsetting wager transaction that would reduce the total level of risk exposure.

What is claimed is:

1-20. (canceled)

21. An apparatus comprising:
a non-transitory machine readable medium having stored thereon a plurality of instructions that when executed by a computing device cause the computing device to:
determine an amount of money wagered on each side of a two sided wager proposition through a first wagering venue;
determine a level of risk exposure for a first side of the two sided wager proposition based on money wagered on the first side;
determine a level of offsetting risk for the first side of the two sided wager proposition based on money wagered on a second side of the two sided wager proposition;
determine a total level of risk exposure based on the risk exposure and the offsetting risk exposure;
determine that the total risk exposure is greater than a threshold value; and
in response to determining that the total risk exposure is greater than the threshold value, facilitate a hedging transaction to offload at least a part of the total level of risk.

22. The apparatus of claim 21, in which the computing device is caused to:
determine a second amount of money wagered on each side of the two sided wager proposition through a second wagering venue;
in which determining the level of risk exposure includes determining the level of risk exposure based on money wagered through both the first and second wagering venues; and
in which determining the level of offsetting risk exposure includes determining the level of offsetting risk exposure based on money wagered through both the first and second wagering venues.

23. The apparatus of claim 22, in which facilitating the hedging transaction includes directing a third wagering facility that is distinct from the first and second wagering facilities to engage in a wagering action such that a sum of risks across the first, second, and third wagering facilities would be below the threshold level after the wagering action.

24. The apparatus of claim 21, in which the hedging transaction includes selling responsibility for one or more wagers to a second wagering venue.

25. The apparatus of claim 21, in which the hedging transaction includes placing an order through an exchange on which wagers may be purchased and sold.

26. The apparatus of claim 21, in which the hedging transaction includes entering into a wager with a second wagering venue.

27. The apparatus of claim 21, in which facilitating the hedging transaction includes directing a second wagering facility that is distinct from the first wagering facility to engage in a wagering action.

28. The apparatus of claim 21, in which facilitating a hedging transaction includes determining whether a transaction that would reduce the total risk exposure is legal in a jurisdiction of the first wagering venue, and if the transaction is legal, engaging in the transaction locally, and if the transaction is not legal, communicating the total risk exposure to a central authority in a different jurisdiction so that the central authority may engage in the transaction.

29. The apparatus of claim 28, in which the apparatus further comprises the central authority and in which the central authority is configured to receive a plurality of risk levels for the wager propositions from various wagering venues, sum the various risk levels, and facilitate hedging of the summed risk.

30. The apparatus of claim 21, in which facilitating the hedging transaction includes attempting to have both a second and third wagering venues engage the hedging transaction.

31. The apparatus of claim 30, in which the computing device is caused to determine that the second wagering venue engaging in a part of the hedging transaction and adjusting the attempts by the third wagering venue to only include an attempt to engage in a remaining part of the hedging transaction.

32. The apparatus of claim 21, in which determining the amount of money wagered on each side includes receiving a report from the first wagering venue indicating the amount of money.

33. The apparatus of claim 32, in which the report is transmitted in a manner that is allowed by a jurisdiction of the first wagering venue and in which a second amount of money wagered through a second wagering venue is received from a second wagering venue in a different jurisdiction in a different manner that is allowed in the second jurisdiction but not the first jurisdiction.

34. The apparatus of claim 21, in which the level of risk exposure includes an amount of money that the first wagering venue would be responsible for paying out if the first side of the wager proposition is a winning side.

35. The apparatus of claim 21, in which the two sided wager proposition includes a fixed odds wager on the outcome of a sporting event.

36. The apparatus of claim 21, in which the computing device is caused to instruct the first wagering venue and a second wagering venue to offer the two sided wager proposition at a different odds in response to determine that the total risk is greater than the threshold value.

37. A method comprising:
determining an amount of money wagered on each side of a two sided wager proposition through a first wagering venue;
determining, by a computing device, a level of risk exposure for a first side of the two sided wager proposition based on money wagered on the first side;
determining, by the computing device, a level of offsetting risk for the first side of the two sided wager proposition based on money wagered on a second side of the two sided wager proposition;
determining, by the computing device, a total level of risk exposure based on the risk exposure and the offsetting risk exposure;
determining, by the computing device, that the total risk exposure is greater than a threshold value; and
in response to determining that the total risk exposure is greater than the threshold value, facilitating, by the computing device, a hedging transaction to offload at least a part of the total level of risk.

38. An apparatus comprising:
a non-transitory machine readable medium having stored thereon a plurality of instructions that when executed by a computing device cause the computing device to:
receive a first level of risk exposure for a first side of a two sided wager proposition based on money wagered on the first side at a first wagering venue;
receive a second level of risk exposure for the first side of the two sided wager proposition based on money wagered on the first side at a second wagering venue;
receive a third level of risk exposure for a second side of the two sided wager proposition based on money wagered on the second side at a third wagering venue;
determine a total level of risk exposure of a gaming operator by summing the first level and the second level and subtracting the third level;
in response to determining the total level of risk exposure, direct a fourth wagering venue to engage in an offsetting wager transaction that would reduce the total level of risk exposure.

39. A method comprising:
receiving, by a computing device, a first level of risk exposure for a first side of a two sided wager proposition based on money wagered on the first side at a first wagering venue;
receiving, by the computing device, a second level of risk exposure for the first side of the two sided wager proposition based on money wagered on the first side at a second wagering venue;
receiving, by the computing device, a third level of risk exposure for a second side of the two sided wager proposition based on money wagered on the second side at a third wagering venue;
determining, by the computing device, a total level of risk exposure of a gaming operator by summing the first level and the second level and subtracting the third level;
in response to determining the total level of risk exposure, directing, by the computing device, a fourth wagering venue to engage in an offsetting wager transaction that would reduce the total level of risk exposure.

40. An apparatus comprising:
a first risk module configured to determine a first level of risk exposure for a first side of a two sided risk proposition based on money risked on the first side at a first gaming venue;
a second risk module configured to determine a second level of risk exposure for the first side of the two sided risk proposition based on money risked on the first side at a second gaming venue;
a third risk module configured to determine a third level of risk exposure for a second side of the two sided risk proposition based on money risked on the second side at a third gaming venue; and
a risk manager configured to determine a total level of risk exposure of a gaming operator by summing the first level and the second level and subtracting the third level, and in response to determining the total level of risk exposure, direct a risk offsetting module to cause a fourth gaming venue to engage in an offsetting risk transaction that would reduce the total level of risk exposure.

41. An apparatus comprising:
a first risk module configured to determine an amount of money risked on each side of a two sided risk proposition through a first gaming venue, determine a level of risk exposure for a first side of the two sided risk proposition based on money risked on the first side, determine a level of offsetting risk for the first side of the two sided risk proposition based on money risked on a second side of the two sided risk proposition, and determine a total level of risk exposure based on the risk exposure and the offsetting risk exposure; and
a risk manager configured to determine that the total risk exposure is greater than a threshold value, and in response to determining that the total risk exposure is greater than the threshold value, facilitate a hedging transaction to offload at least a part of the total level of risk.
